(19) United States
(12) Patent Application Publication
(10) Pub. No.: US 2026/0204135 A1
(43) Pub. Date: Jul. 16, 2026

(54) SYSTEMS AND METHODS FOR CONTROLLING THE RATE OF LANDING OF TARGET GAME PATTERNS IN AN RNG-DRIVEN GAMING ARCHITECTURE

(71) Applicant: Aristocrat Technologies, Inc., Las Vegas, NV (US)

(72) Inventors: Jack Sergison, London (GB); Georgi Tsvetanski, Sofia (BG)

(21) Appl. No.: 19/404,474

(22) Filed: Dec. 1, 2025

Related U.S. Application Data
(60) Provisional application No. 63/745,672, filed on Jan. 15, 2025.

(51) Int. Cl. G07F 17/32

(52) U.S. Cl. CPC G07F 17/326; G07F 17/3258

(57) ABSTRACT

Systems and methods for electronic gaming are provided. The systems and methods include performing an RNG pull and memory lookup in a first lookup table to determine and store a minimum number of winning game patterns that a feature game will generate. Initial trigger symbols and additional trigger symbols are determined for display within symbol positions of a feature game symbol matrix. Symbol positions are selected as part of a symbol filling processing stage. After filling of unoccupied symbol positions in the symbol filling processing stage, the filled symbol positions of the feature game symbol matrix are compared to the minimum number of winning game patterns stored in at least one memory device to determine that the minimum number of winning game patterns has been satisfied. A symbol set for the feature game is generated, and the feature game is implemented using the generated feature game symbol set.

### CROSS-REFERENCE TO RELATED APPLICATION

This application claims the benefit of priority of U.S. Provisional Application No. 63/745,672, filed Jan. 15, 2025, titled “SYSTEMS AND METHODS FOR CONTROLLING THE RATE OF LANDING OF TARGET GAME PATTERNS IN A RANDOM BASED GAMING ENVIRONMENT,” the contents and disclosures of which are hereby incorporated herein by reference in their entirety.

### TECHNICAL FIELD

The field of disclosure relates generally to electronic gaming, and more specifically, to electronic gaming systems and methods that include controlling the rate of landing of one or more target game patterns that trigger additional wins in a random number generator (RNG)-driven gaming architecture.

### BACKGROUND

Electronic gaming machines (“EGMs”) or gaming devices including mobile devices and/or end user devices provide a variety of wagering games such as slot games, video poker games, video blackjack games, roulette games, video bingo games, keno games and other types of games (e.g., online games) that are frequently offered at casinos and other locations (including at a player's home via gaming on mobile and/or end user devices such as tablets and laptops).

Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Play on mobile devices and other end user devices such as tablets and laptops may include online gaming, which may also be referred to herein as “iGaming.” iGaming systems may include front-end and back-send services for the providing and managing of gaming on mobile and/or end user devices. Gaming on mobile and/or end user devices may generally approximate the look and feel of a gaming experience a player playing at an EGM would encounter.

However, iGaming may also differ from EGM-based gaming in a variety of ways. iGaming offers near instant accessibility and convenience, effectively providing the ability to play anytime, anywhere. iGaming may offer increased game variety and features compared to EGM gaming. iGaming may have increased social interaction compared to EGM gaming and may include features such as chat features for social interaction. iGaming may utilize different wagering dynamics than EGM gaming, which may involve more complex strategies and more interactive elements.

Typical games (e.g., both EGM and iGaming games) use an RNG to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a system for electronic gaming is provided. The system includes at least one memory device storing instructions and at least one processor in communication with the at least one memory device. The instructions, when executed by the at least one processor, cause the system to perform a random number generator (RNG) pull and associated memory lookup in a first lookup table stored in the at least one memory device to determine a minimum number of winning game patterns that a feature game will generate, the feature game being associated with a base game. The instructions, when executed by the at least one processor, further cause the system to store the determined minimum number of winning game patterns in the at least one memory device. The instructions, when executed by the at least one processor, further cause the system to determine, for display within symbol positions of a feature game symbol matrix, one or more initial trigger symbols and one or more additional trigger symbols. The instructions, when executed by the at least one processor, further cause the system to select, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols. The instructions, when executed by the at least one processor, further cause the system to, after each filling of an unoccupied symbol position in the symbol filling processing stage, compare filled symbol positions of the feature game symbol matrix to the minimum number of winning game patterns stored in the at least one memory device. The instructions, when executed by the at least one processor, further cause the system to determine that the minimum number of winning game patterns has been satisfied. The instructions, when executed by the at least one processor, further cause the system to generate a symbol set for the feature game, the symbol set including the one or more initial trigger symbols and the one or more additional trigger symbols resulting from the symbol filling processing stage. The instructions, when executed by the at least one processor, further cause the system to cause the feature game to be implemented using the generated feature game symbol set.

In another aspect, a computer-implemented method for electronic gaming implemented using at least one memory device having instructions stored thereon and at least one processor in communication with the at least one memory device is provided. The computer-implemented method includes performing a random number generator (RNG) pull and associated memory lookup in a first lookup table stored in the at least one memory device to determine a minimum number of winning game patterns that a feature game will generate, the feature game being associated with a base game. The computer-implemented method further includes storing the determined minimum number of winning game patterns in the at least one memory device. The computer-implemented method further includes determining, for display within symbol positions of a feature game symbol matrix, one or more initial trigger symbols and one or more additional trigger symbols. The computer-implemented method further includes selecting, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols. The computer-implemented method further includes after each filling of an unoccupied symbol position in the symbol filling processing stage, comparing filled symbol positions of the feature game symbol matrix to the minimum number of winning game patterns stored in the at least one memory device. The computer-implemented method further includes determining that the minimum number of winning game patterns has been satisfied. The computer-implemented method further includes generating a symbol set for the feature game, the symbol set including the one or more initial trigger symbols and the one or more additional trigger symbols resulting from the symbol filling processing stage. The computer-implemented method further includes causing the feature game to be implemented using the generated feature game symbol set.

In yet another aspect, one or more non-transitory computer-readable storage media containing instructions thereon for controlling one or more electronic gaming devices are provided. The instructions, when executed by one or more processors of the one or more electronic gaming devices, cause the one or more processors to perform a random number generator (RNG) pull and associated memory lookup in a first lookup table stored in the at least one memory device to determine a minimum number of winning game patterns that a feature game will generate, the feature game being associated with a base game. The instructions, when executed by one or more processors of the one or more electronic gaming devices, further cause the one or more processors to store the determined minimum number of winning game patterns in the at least one memory device. The instructions, when executed by one or more processors of the one or more electronic gaming devices, further cause the one or more processors to determine, for display within symbol positions of a feature game symbol matrix, one or more initial trigger symbols and one or more additional trigger symbols. The instructions, when executed by one or more processors of the one or more electronic gaming devices, further cause the one or more processors to select, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols. The instructions, when executed by one or more processors of the one or more electronic gaming devices, further cause the one or more processors to after each filling of an unoccupied symbol position in the symbol filling processing stage, compare filled symbol positions of the feature game symbol matrix to the minimum number of winning game patterns stored in the one or more non-transitory computer-readable storage media. The instructions, when executed by one or more processors of the one or more electronic gaming devices, further cause the one or more processors to determine that the minimum number of winning game patterns has been satisfied. The instructions, when executed by one or more processors of the one or more electronic gaming devices, further cause the one or more processors to generate a symbol set for the feature game, the symbol set including the one or more initial trigger symbols and the one or more additional trigger symbols resulting from the symbol filling processing stage. The instructions, when executed by one or more processors of the one or more electronic gaming devices, further cause the one or more processors to cause the feature game to be implemented using the generated feature game symbol set.

In one additional aspect, a system for electronic gaming including at least one memory device storing instructions and at least one processor in communication with the at least one memory device is provided. The instructions, when executed by the at least one processor, cause the system to cause display of an initial quantity of trigger symbols each within a symbol position of a symbol matrix of a base game of an electronic game, the initial quantity of trigger symbols triggering a feature game. The instructions, when executed by the at least one processor, further cause the system to cause the initial quantity of trigger symbols to be persistent by continuing to be displayed in same symbol positions in the symbol matrix of the feature game as in the base game symbol matrix. The instructions, when executed by the at least one processor, further cause the system to perform a random number generator (RNG) pull and associated memory lookup to determine a minimum number of winning game patterns the feature game will generate, wherein the at least one memory includes a local memory device. The instructions, when executed by the at least one processor, further cause the system to store the determined minimum number of winning game patterns in the local memory device. The instructions, when executed by the at least one processor, further cause the system to randomly determine, for display within the symbol positions of the feature game symbol matrix, one or more additional trigger symbols. The instructions, when executed by the at least one processor, further cause the system to randomly select, as part of a symbol filling processing stage, symbol positions of the feature game symbol matrix in which to place respective trigger symbols of the one or more additional trigger symbols, based on a determination of if the symbol positions are already occupied by a trigger symbol. The instructions, when executed by the at least one processor, further cause the system to after each filling of an unoccupied symbol position in the symbol filling processing stage, compare each filled symbol position of the feature game symbol matrix to the minimum number of winning game patterns stored in the local memory device. The instructions, when executed by the at least one processor, further cause the system to determine that the minimum number of winning game patterns has been satisfied. The instructions, when executed by the at least one processor, further cause the system to generate a symbol set for the feature game, the symbol set including the initial quantity of trigger symbols and each trigger symbol resulting from the symbol filling processing stage. The instructions, when executed by the at least one processor, further cause the system to cause the feature game to be implemented using the generated feature game symbol set.

In another additional aspect, a computer-implemented method for electronic gaming implemented using at least one memory device having instructions stored thereon and at least one processor in communication with the at least one memory device is provided. The computer-implemented method includes causing display of an initial quantity of trigger symbols each within a symbol position of a symbol matrix of a base game of an electronic game, the initial quantity of trigger symbols triggering a feature game. The computer-implemented method further includes causing the initial quantity of trigger symbols to be persistent by continuing to be displayed in same symbol positions in the symbol matrix of the feature game as in the base game symbol matrix. The computer-implemented method further includes performing a random number generator (RNG) pull and associated memory lookup to determine a minimum number of winning game patterns the feature game will generate, wherein the at least one memory device includes a local memory device. The computer-implemented method further includes storing the determined minimum number of winning game patterns in the local memory device. The computer-implemented method further includes randomly determining, for display within the symbol positions of the feature game symbol matrix, one or more additional trigger symbols; randomly selecting, as part of a symbol filling processing stage, symbol positions of the feature game symbol matrix in which to place respective trigger symbols of the one or more additional trigger symbols, based on a determination of if the symbol positions are already occupied by a trigger symbol. The computer-implemented method further includes after each filling of an unoccupied symbol position in the symbol filling processing stage, comparing each filled symbol position of the feature game symbol matrix to the minimum number of winning game patterns stored in the local memory device. The computer-implemented method further includes determining that the minimum number of winning game patterns has been satisfied. The computer-implemented method further includes generating a symbol set for the feature game, the symbol set including the initial quantity of trigger symbols and each trigger symbol resulting from the symbol filling processing stage. The computer-implemented method further includes causing the feature game to be implemented using the generated feature game symbol set.

In yet another additional aspect, one or more non-transitory computer-readable storage media containing instructions thereon for controlling one or more electronic gaming devices is provided. The instructions, when executed by one or more processors of the one or more electronic gaming devices, cause the one or more processors to cause display of an initial quantity of trigger symbols each within a symbol position of a symbol matrix of a base game of an electronic game, the initial quantity of trigger symbols triggering a feature game. The instructions, when executed by one or more processors of the one or more electronic gaming devices, further cause the one or more processors to cause the initial quantity of trigger symbols to be persistent by continuing to be displayed in same symbol positions in the symbol matrix of the feature game as in the base game symbol matrix. The instructions, when executed by one or more processors of the one or more electronic gaming devices, further cause the one or more processors to perform a random number generator (RNG) pull and associated memory lookup to determine a minimum number of winning game patterns the feature game will generate, wherein the one or more non-transitory computer-readable storage media includes one or more local memory devices. The instructions, when executed by one or more processors of the one or more electronic gaming devices, further cause the one or more processors to store the determined minimum number of winning game patterns in the one or more local memory devices. The instructions, when executed by one or more processors of the one or more electronic gaming devices, further cause the one or more processors to randomly determine, for display within the symbol positions of the feature game symbol matrix, one or more additional trigger symbols; randomly select, as part of a symbol filling processing stage, symbol positions of the feature game symbol matrix in which to place respective trigger symbols of the one or more additional trigger symbols, based on a determination of if the symbol positions are already occupied by a trigger symbol. The instructions, when executed by one or more processors of the one or more electronic gaming devices, further cause the one or more processors to after each filling of an unoccupied symbol position in the symbol filling processing stage, compare each filled symbol position of the feature game symbol matrix to the minimum number of winning game patterns stored in the one or more local memory devices. The instructions, when executed by one or more processors of the one or more electronic gaming devices, further cause the one or more processors to determine that the minimum number of winning game patterns has been satisfied. The instructions, when executed by one or more processors of the one or more electronic gaming devices, further cause the one or more processors to generate a symbol set for the feature game, the symbol set including the initial quantity of trigger symbols and each trigger symbol resulting from the symbol filling processing stage. The instructions, when executed by one or more processors of the one or more electronic gaming devices, further cause the one or more processors to cause the feature game to be implemented using the generated feature game symbol set.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A and 4B illustrate exemplary screenshots and/or game interfaces according to an embodiment of the present disclosure.

FIGS. 5A to 5G illustrate exemplary screenshots and/or game interfaces according to an embodiment of the present disclosure.

FIGS. 5H to 5J illustrate additional exemplary screenshots and/or game interfaces according to an embodiment of the present disclosure.

FIGS. 5K to 5M illustrate additional exemplary screenshots and/or game interfaces according to an embodiment of the present disclosure.

FIG. 6 illustrates an exemplary screenshot and/or game interface according to an embodiment of the present disclosure.

FIGS. 7A to 7C illustrate a screenshot and/or game interface according to an alternative embodiment of the present disclosure.

FIGS. 8A to 8C are diagrams illustrating exemplary game outcome mechanics according to an embodiment of the present disclosure.

FIG. 9A is a block diagram illustrating exemplary spin mechanics according to an embodiment of the present disclosure.

FIG. 9B is a block diagram illustrating exemplary script aspects according to an embodiment of the present disclosure.

FIG. 10 illustrates an example configuration of mobile and/or end user devices that players may use to play the electronic game shown in FIGS. 4A, 4B, 5A-5G, 6, 7A-7C and/or 13A-13J.

FIG. 11 illustrates an example method for providing the electronic game shown in FIGS. 4A, 4B, 5A-5G, 6, 7A-7C and/or 13A to 13J.

FIGS. 12A to 12C illustrate example weighted tables according to an embodiment of the present disclosure.

FIGS. 13A to 13J illustrate exemplary screenshots and/or game interfaces according to an embodiment of the present disclosure.

### DETAILED DESCRIPTION

Described herein are gaming systems and methods configured to control a rate at which one or more target game patterns, such as bingo line win patterns, occur within an RNG-driven gaming architecture. The RNG-driven gaming architecture described herein is configured to control the rate of winning outcomes within a hold and spin feature by determining, through an RNG call or pull, a number of bingo line wins that the feature game may produce. Trigger symbols (e.g., credit symbols) are then randomly added to symbol matrix positions until at least a minimum number of bingo line wins has been achieved. This approach enables control over randomness without compromising fairness or unpredictability, as the placement of trigger symbols does not rely on reel strips but instead uses RNG-based determination to achieve balanced and consistent feature game outcomes. In contrast, convention gaming systems predetermine the number of target game patterns, and therefore, lack the control over the randomness of the game. The present system is a significant improvement over conventional systems by providing improved control over the randomness of the game while still providing fairness and unpredictability.

The gaming systems and methods described herein further include techniques for controlling and/or tracking so-called “dead spins” in a game (e.g., a feature game such as a hold and spin-based feature game) where the “dead spins” may correlate to a prolonged period of time in between notable wins during a session of play of the feature game. The “dead spin” control processes described herein improve the flow of the game and reduce the likelihood of occurrence and/or burden of the system with respect to a high frequency of “dead spins” that lead, for example, to poor randomness distribution. The “dead spin” control aspects described herein thus provide an additional improvement over conventional systems.

The term “Hold and Spin” (which can also be referenced herein as “Hold and Respin,” “Hold and Win,” “Lock and Win,” “Lock and Spin,” “Link and Win,” and/or “Lock and Respin”) is understood to describe a game feature in which one or more designated symbols, outcomes, and/or indicators are retained (e.g., “held” or “locked”) upon occurrence of a triggering event, while the remaining non-held symbols or positions are re-spun, re-evaluated, and/or otherwise re-randomized for one or more subsequent game iterations. That is, unlike classic slot gameplay that relies on spinning reels and paylines, hold and spin slots introduce a feature where specific symbols are “held” in place while the reels respin, increasing the chance of landing valuable combinations. Additional aspects of the “Hold and Spin” feature (more simply referenced herein as “hold and spin” with or without quotations) of the present disclosure are described below.

Initially, landing certain symbols on the standard reel set (e.g., of a base game) may trigger play of a feature game. The feature game may utilize hold and spin techniques and include free spins (e.g., respins) as described herein. The feature game may include the standard reel set as part of the feature game or a modified (e.g., expanded) reel set, or a combination thereof. The trigger symbols that triggered the feature game may be held in place to be persistent in the same symbol positions as in the base game. The symbol matrix of the feature game may include more rows and/or columns than the symbol matrix of the base game, for example to better accommodate bingo line wins (e.g., in connection with the five letters of the word bingo). In the feature game, other symbol positions within the symbol matrix may be left blank/empty so that new trigger symbols may land. These new trigger symbols may integrate with the held trigger symbols to trigger bingo line wins in each free spin of the feature game, and/or may award additional free spins of the feature game. Once the feature game concludes, the player may be apprised of the various winnings resulting from the feature game via a prize/win interface and be returned to the base game. Additional aspects of the feature game and hold and spin feature are described below.

In the base game, standard symbols form winning combinations across paylines. In general, these standard symbols typically include low-value icons (e.g., such as card ranks: 10, J, Q, K, A) and higher-value symbols that may be tied to the game's theme, such as treasures, animals, and/or mythical objects. Winning combinations require matching symbols on active paylines, with payouts based on the game's paytable. The hold and spin feature may be activated by landing a specific number of trigger symbols in the base game, where the trigger symbols may be depicted as coins, gemstones, and the like, and in some embodiments have associated credit values. Typically, a certain minimum number of trigger symbols need to land in order to initiate a feature game (e.g., landing six or more trigger symbols in the base game initiates the feature game including the hold and spin feature). These trigger symbols then lock into place for the feature game, and the player receives a set number of respins to try to land additional trigger symbols and/or other awards/prizes such as jackpots, tokens, and/or multipliers in the feature game.

Each trigger symbol that is carried over from the base game and/or that lands during a respin of the feature game may carry a credit/cash value and, if part of a winning game pattern, may be associated with awards such as tokens and multipliers. For example, certain rows and/or columns of a symbol matrix of the feature game may be associated with designated modifiers such as (i) multiplier symbols that may be configured to boost (e.g., multiply) the value of certain symbols, (ii) collector symbols that may be configured to gather the values of other symbols on the reels, and add them to a single payout, (iii) jackpot symbols that may be configured to unlock fixed and/or progressive jackpots, such as Mini, Minor, Major, and/or Grand jackpots, where tokens may be implemented as part of the jackpot awarding process, and/or (iv) mystery symbols that may be configured to reveal a random award such as a random cash value, multiplier, and/or jackpot at the end of the session of play.

Once a feature game or bonus game including a hold and spin feature is triggered from a triggering event in the base game, the base game may transition to a new screen via animations, graphics, and the like for play of the feature game, with a focus on the trigger symbols. The feature game may, compared to the base game, include a different amount and/or configuration of reels of a symbol matrix and/or other changes to aspects of gameplay from the base game. For example, a 3×3 symbol matrix in the base game may expand to a 5×5 matrix in the feature game. The landed symbols from the base game that activated the hold and spin feature “hold” or “lock” in their positions and are carried over to the feature game, while all other positions on the reels may become blank and subject to respin in the feature game. An initial play of the feature game that includes the hold and spin feature may include an award of a set number of “respins” (e.g., three respins) and there may be chances to be awarded additional respins during subsequent spins of the feature game to extend a play session of the feature game.

For example, one goal of a player in a hold and spin-based feature game is to land more of the trigger symbols and/or symbol combinations that will add additional respins and/or award additional winnings. In one embodiment herein, a diamond symbol may be set as the trigger symbol with respect to the hold and spin game feature. In some aspects, each time a new (e.g., diamond) symbol lands, the new (e.g., diamond) symbol also locks into place (e.g., in addition to the symbols that were previously locked into place upon initiation of the hold and spin from the base game to the feature game), and the respin counter may be reset back to its starting number (e.g., three) and/or otherwise incremented (e.g., increased) in view of the additional landed and locked trigger symbol(s). These aspects demonstrate the “hold” and “spin” part of the name of the game feature. The hold and spin game feature continues until the player either runs out of respins or manages to fill every position on the grid with the designated symbol(s) such as the trigger symbols.

A technical problem exists in how an RNG-driven gaming architecture can effectively manage and control the degree of randomness to achieve a desired distribution of target game patterns (e.g., bingo lines) when trigger symbols are landed during gameplay. Conventional game logic employing independent reels provides limited control over randomness and often results in inconsistent landing rates of target game patterns, such as sequences that may generate additional bonuses or prizes that supplement those associated with the trigger symbols. Because the occurrence of such patterns is determined by independent random outcomes, the game may produce an undesirably high number of feature plays with no wins, commonly referred to as “dead spins.” A high frequency of dead spins leads to a poor randomness distribution, disrupting the balance of feature play outcomes. This lack of controlled randomness diminishes the intended effect of target game patterns that are meant to trigger enhanced bonus events or prizes. The problem therefore lies in developing a process for regulating random symbol generation so that randomness remains fair and unpredictable while maintaining consistency in landing rates of target game patterns and reducing the occurrence of dead spins within the RNG-driven gaming architecture.

The technical solution regulates the degree of randomness within an RNG-driven gaming architecture. More specifically, the technical solution controls and manages (i) the rate at which one or more target game patterns that trigger additional wins occur, (ii) how symbols are displayed during a feature game while avoiding reliance on reel strips and mitigating security issues such as reverse engineering on end-user devices, and (iii) the presentation of game outcomes in a manner that maintains both fairness and unpredictability. The gaming operations below illustrate an example implementation of a game processing pipeline that may be performed within the RNG-driven gaming architecture:
Determining a minimum number of winning game patterns. An RNG call or pull and table lookup determine a minimum number of bingo lines or other target patterns that a feature game will generate. During feature play, additional winning patterns may be produced beyond this minimum.
Placing trigger symbols that initiate the feature game. A hold and spin feature may be triggered when a threshold number of trigger symbols land in a base game. When the feature game initiates, those trigger symbols are placed in corresponding positions of the feature-game symbol matrix. In alternative implementations, trigger symbols may be reassigned to different matrix positions using random selection.
Randomly adding target symbols until reaching the minimum number of winning patterns. Target symbols (e.g., diamond, coin, scatter, and/or other special symbols) are added at randomly selected positions within the symbol matrix until the minimum number of bingo lines is achieved. If a position is already occupied, a new position is randomly selected, ensuring randomness without relying on reel-strip stop mapping.
Randomly determining the number of jackpot tokens. To control the number of jackpot tokens awarded based on the number of bingo lines, an RNG call or pull and a table lookup determine the number of tokens to be awarded. Tokens associated with winning patterns may be placed on winning lines, while remaining tokens are placed on non-winning lines.
Randomly generating remaining prizes. Remaining prizes, such as multipliers, are randomly generated and assigned to positions within the symbol matrix. In some implementations, multiplier values are controlled relative to the presence or absence of bingo lines to further manage randomness.
Generating a feature script. After determining the final game outcome, a feature script defines how the outcome is presented to the player. The feature script introduces additional randomness and variation in presentation, enhancing unpredictability while maintaining balanced gameplay.

Through these processes, the technical solution provides controlled management of randomness within the RNG-driven environment, allowing target game patterns to occur at consistent rates, improving the distribution of winning outcomes, and addressing fairness and security considerations without compromising randomness integrity. The disclosed system is technically rooted in gaming technology that controls randomness when generating game outcomes that trigger additional awards in features such as hold and spin features. Additionally, avoiding the use of reel strips provides improved security within the RNG-driven gaming architecture. Specifically, when reel strips are used, it may be possible for a third party to deduce their composition by capturing and analyzing a large number of reel images (e.g., by taking and analyzing a multitude of screenshots (e.g., 1,000 to 2,000 screenshots, etc.)), thereby reverse-engineering the mathematical structure, weighting, and/or symbol distribution. By implementing a system that determines symbol placement without relying on reel strips, the gaming architecture enhances randomness control while also mitigating security risks associated with reverse engineering.

The technical problems addressed herein include: (i) inability for known electronic games to generate a target set of game patterns (e.g., bingo lines) when landing trigger symbols in an RNG-driven gaming architecture; (ii) inability for known electronic games that include a hold and spin feature to randomly determine and place trigger symbols without showing a spinning reel strip; (iii) limited degrees of randomness that may be used to determine which features are provided in known electronic games; (iv) avoiding negating the effect of bingo lines triggering additional bonuses or prizes by seldomly landing such game patterns; (v) avoiding relatively high rates of game outcomes with no winning game patterns (e.g., “dead spins”); and/or (vi) inability to track states of dead spins to assist in avoiding/reducing further dead spins.

The resulting technical effect and/or technical benefits achieved herein include at least one of: (i) improving the control of randomness when generating game outcomes that trigger additional awards in a hold and spin feature; (ii) providing more degrees of variability and randomness in determining which features are provided in electronic games, without the need for additional computer resources such as computer processing and/or memory resources; (iii) providing additional information and gameplay features to a user (e.g., player) of the electronic game within a limited amount of display space via an enhanced graphical user interface (GUI) of the game, including providing, via the GUI, additional information to the user during gameplay to apprise the user of the status of triggering a feature game and enhancement of prizes within the feature game; (iv) reducing the ability for an electronic game to be reverse engineered based on a visual analysis of spinning reel strips by avoiding using reel strips in a feature game (e.g., avoiding “card counting” of spinning reels to reverse engineer a game); (v) increasing security in electronic gaming by reducing the likelihood of reverse engineering; and/or (vi) improving tracking states of dead spins to assist in avoiding/reducing further dead spins.

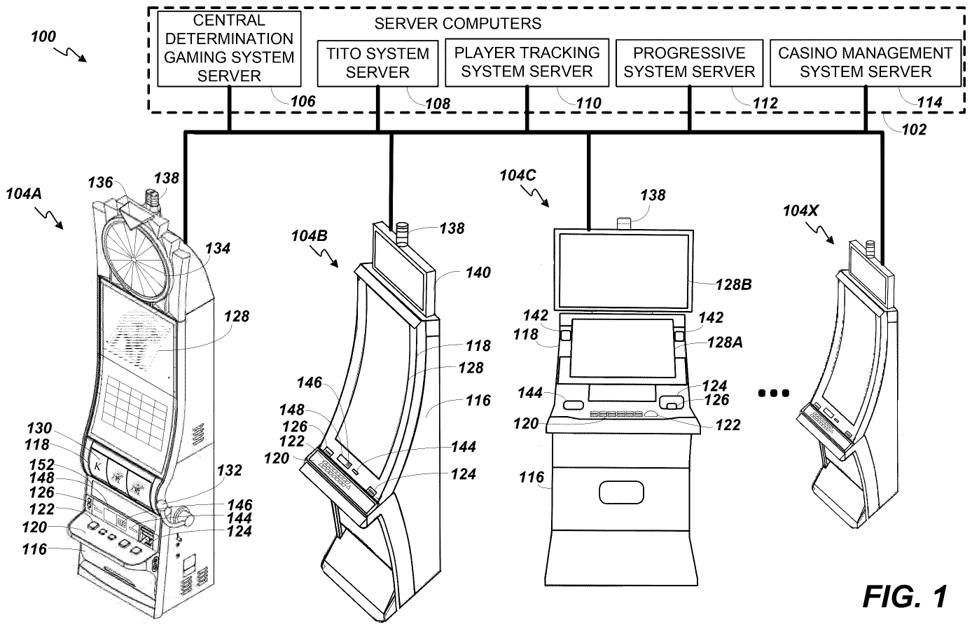

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The

mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.01, $0.02, $0.05, or $0.10), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

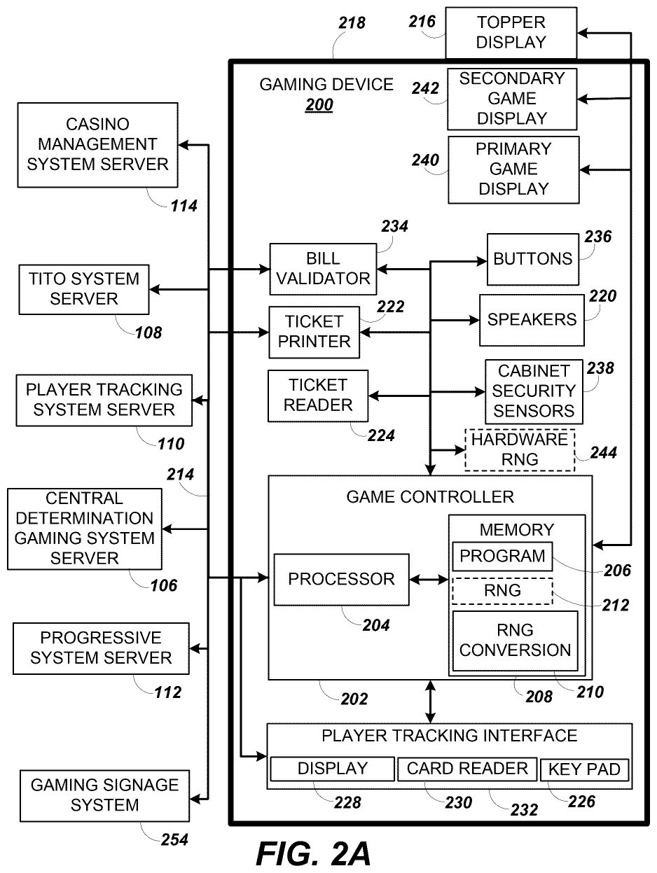

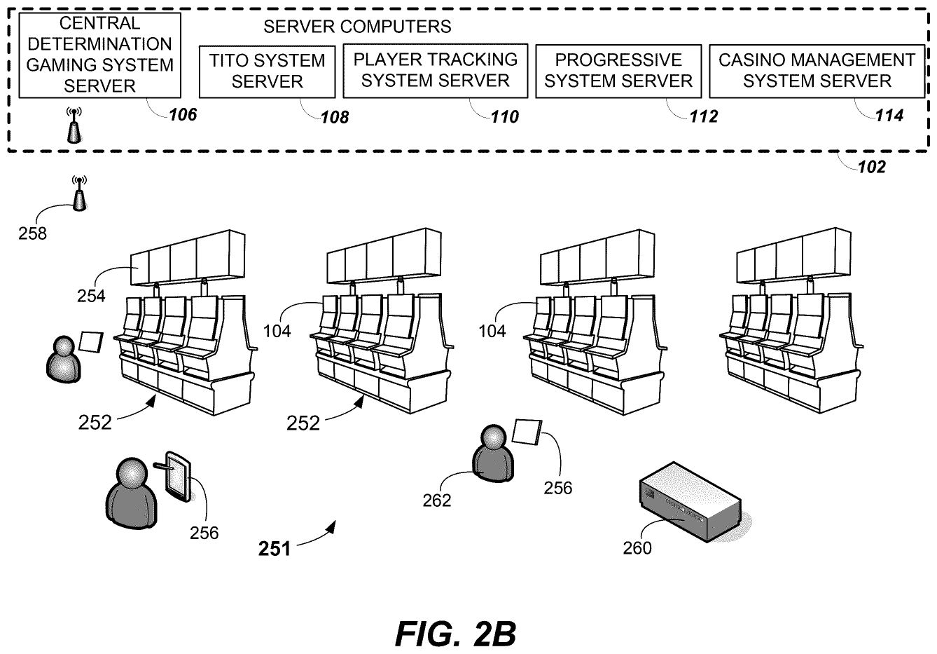

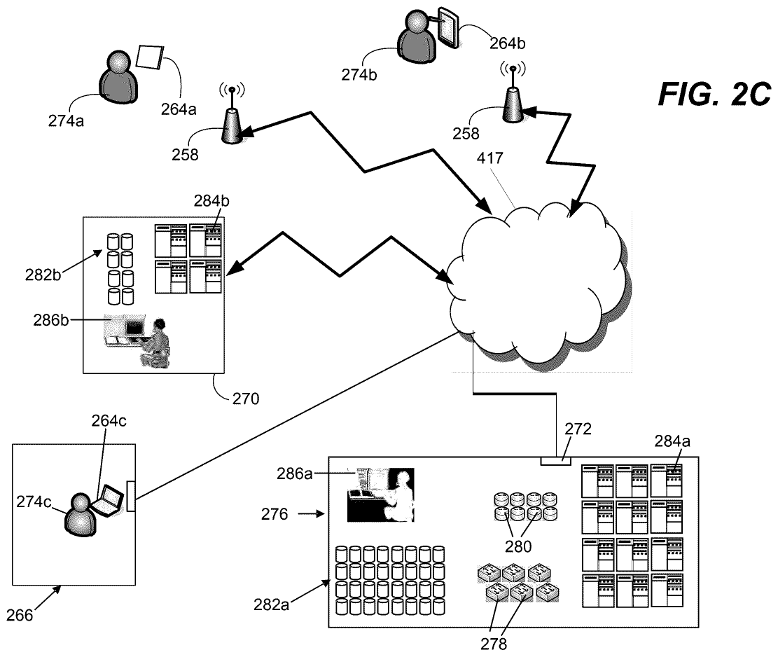

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more user interfaces (UIs), the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104A-104X. In this example, each bank 252 of EGMs 104A-104X includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104A-104X, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real (e.g., physical) button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

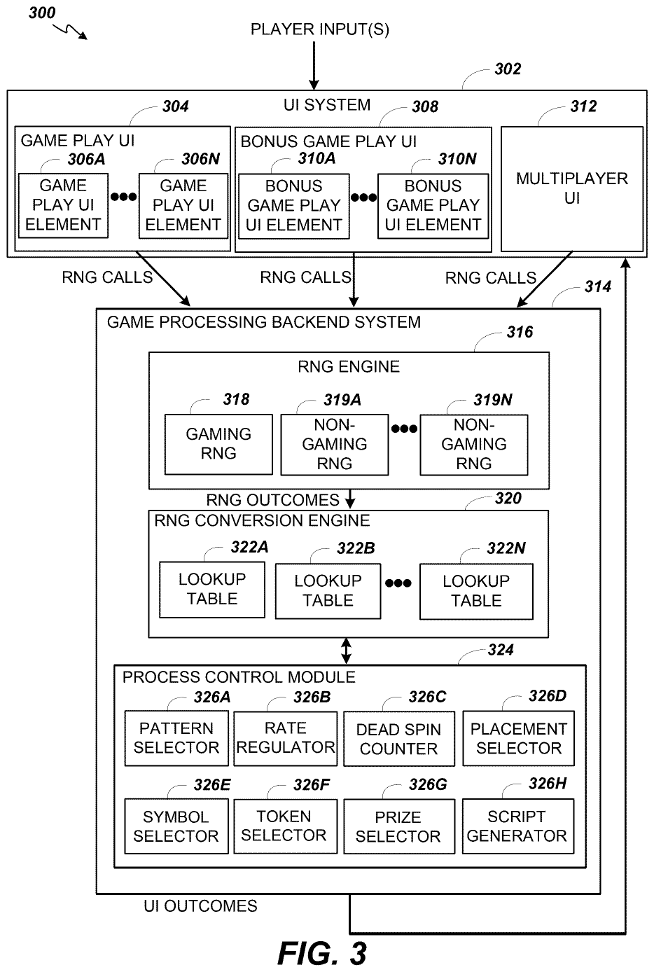

FIG. 3 illustrates, in block diagram form, an implementation of a game processing architecture 300, such as the RNG-driven gaming architecture, that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

FIG. 3 also illustrates that game processing architecture 300, such as the RNG-driven gaming architecture described herein, may include a dedicated software module such as a process control module 324 as part of game processing backend system 314 to execute the various process control aspects described herein. Process control module 324 may be configured to include various control elements including various selectors, counters, and/or generators. In one embodiment, process control module 324 includes a pattern selector 326A, a rate regulator 326B, a dead spin counter 326C, a placement selector 326D, a symbol selector 326E, a token selector 326F, a prize selector 326G, and/or a script generator 326H.

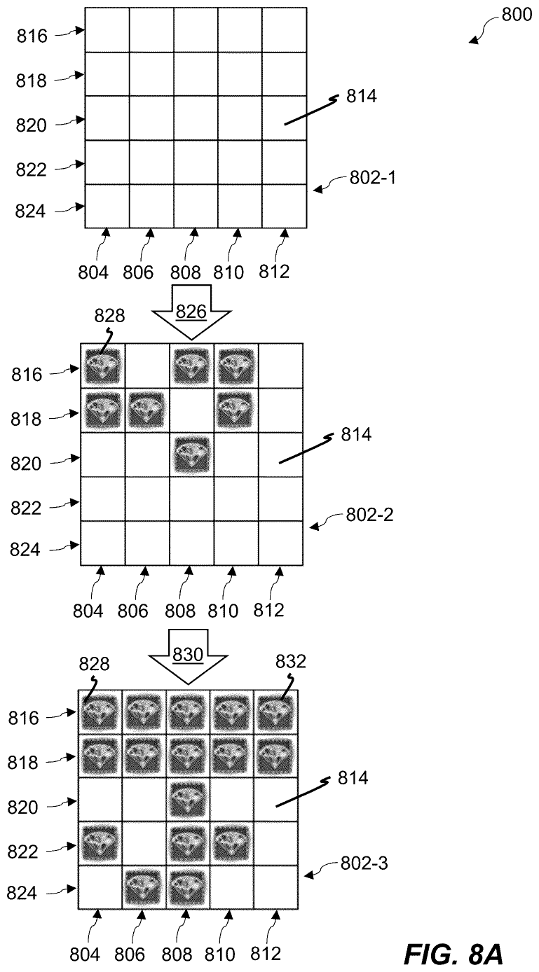

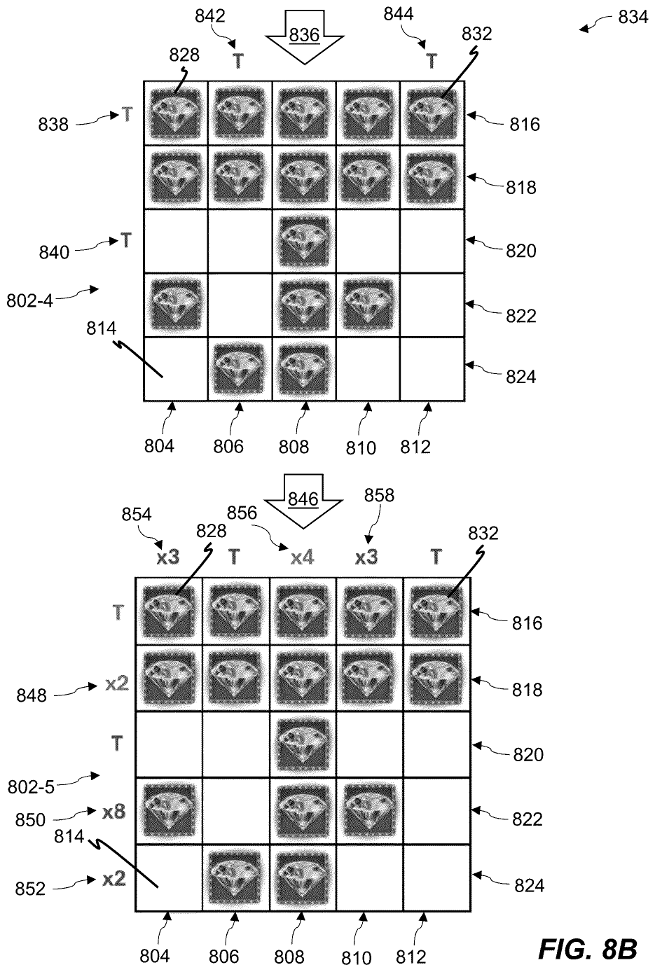

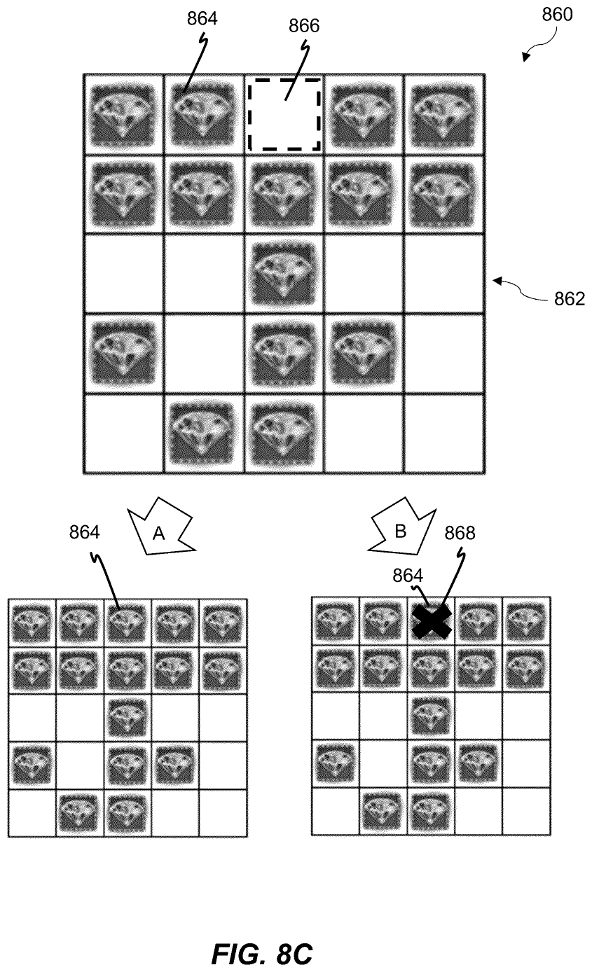

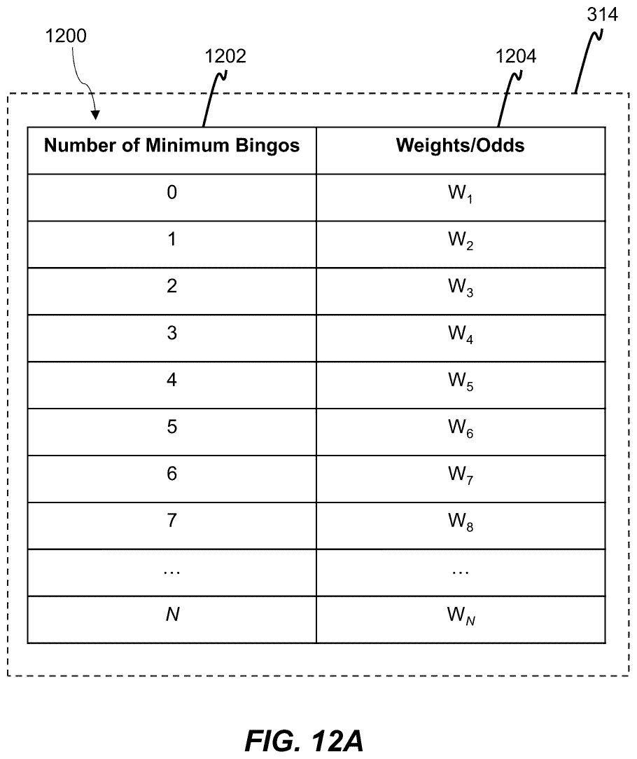

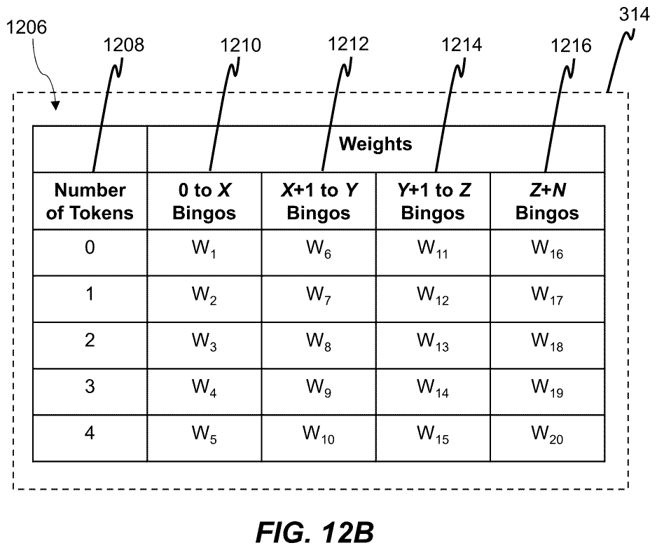

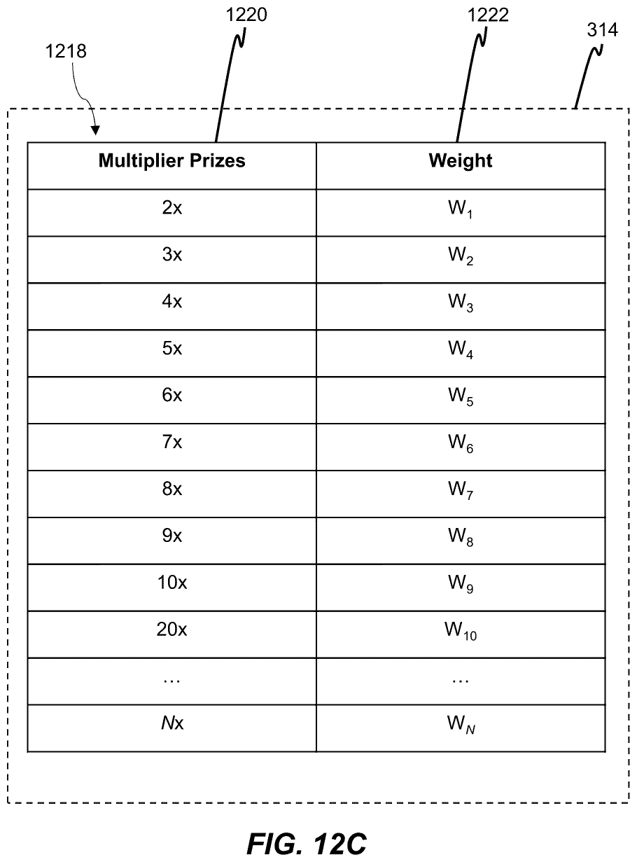

For example, pattern selector 326A may be programmed to select and/or distribute a number of winning game patterns (e.g., bingo line patterns) and control other aspects relating thereto. Rate regulator 326B may be programmed to control a landing rate of patterns, symbols, token, and/or prizes as described herein and control other aspects relating thereto. Dead spin counter 326C may be programmed to count and/or control a number of dead spins within a given gameplay session and control other aspects relating thereto. Placement selector 326D may be programmed to control placement of various elements within a symbol matrix, including placement of symbols, tokens, prizes, and/or other elements as described herein and control other aspects relating thereto. Symbol selector 326E may be programmed to select symbols such as trigger symbols and/or other symbols for a given gameplay session and control other aspects relating thereto. Token selector 326F may be programmed to select a number of tokens for landing during a given gameplay session and control other aspects relating thereto. Prize selector 326G may be programmed to select a number of prizes for landing during a given gameplay session and control other aspects relating thereto. Selectors 326A and 326D to 326G may operate in accordance with dedicated lookup tables as described herein, such as in connection with lookup tables 322A to 322N and the lookup tables shown in and described in connection with FIGS. 12A-12C. Script generator 326H may be programmed to convey the outputs/results from the various control elements 326A to 326G, including visual display of the outcome of the game, which includes the landing of symbols to fill game patterns such as bingo lines and the awarding of any associated tokens and/or prizes with respect to winning lines of a symbol matrix, and control other aspects relating thereto. Control elements 326A-326H are described in greater detail in connection with FIGS. 8A-8C, 9A, 9B, 11, and 12A-12C.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline. For example, script generator 326H may output a script that conveys the outcome of a game instance such as an outcome of an instance of a hold and spin-based feature game as described herein.

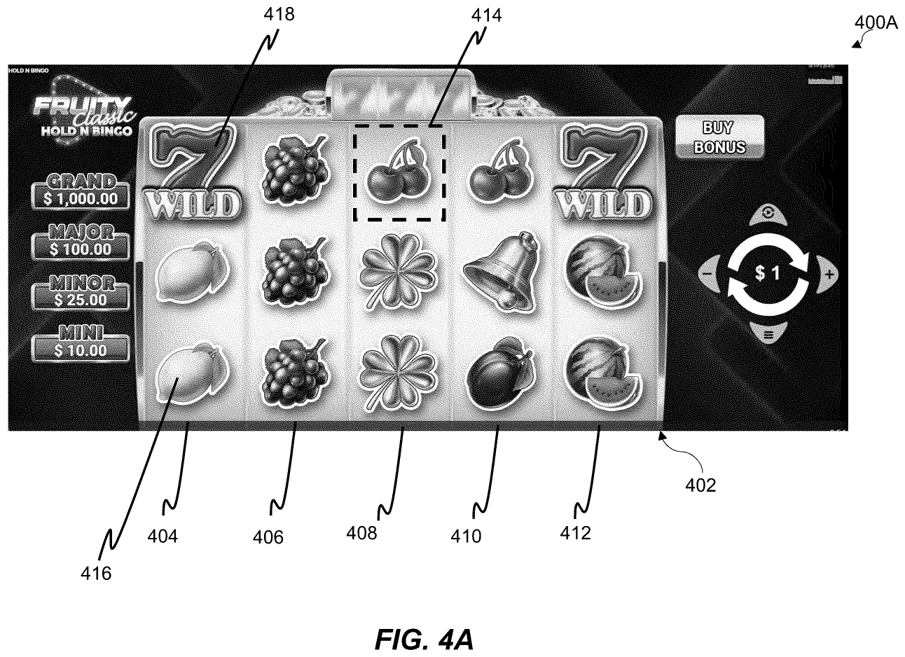

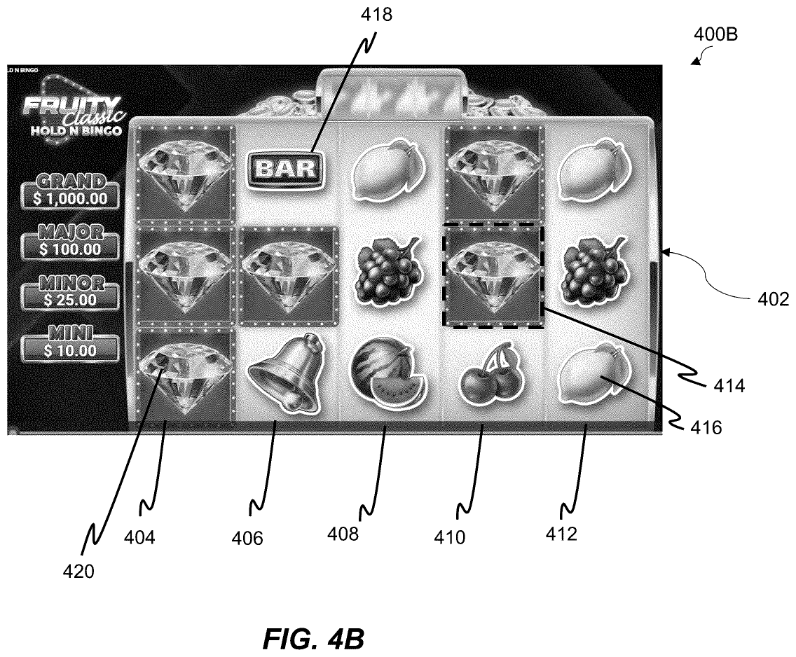

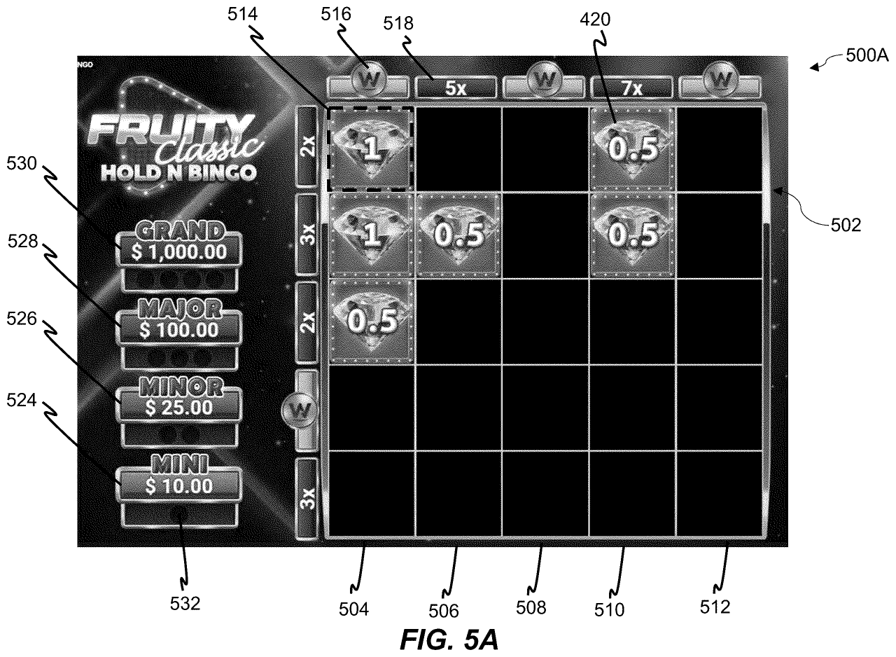

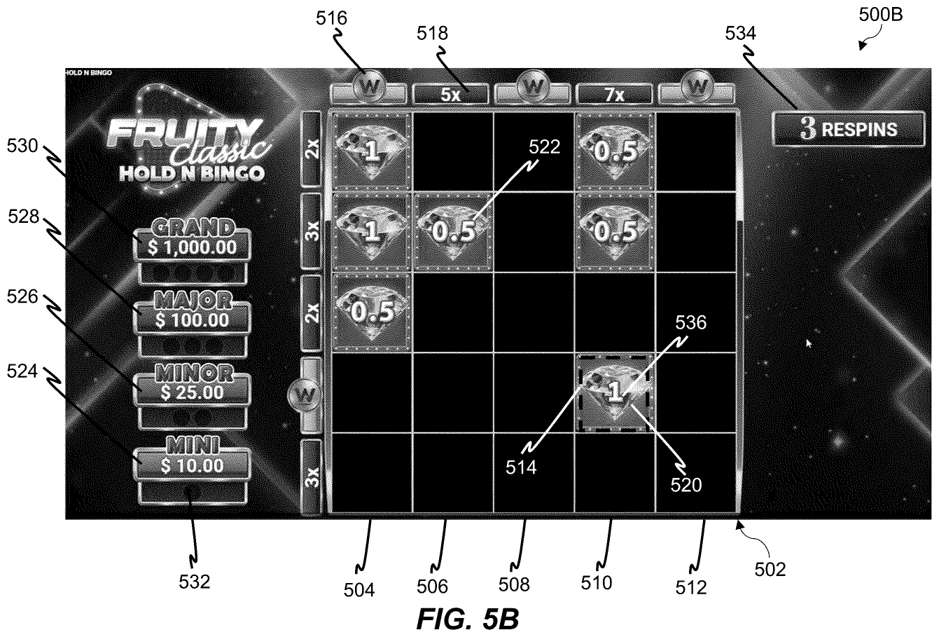

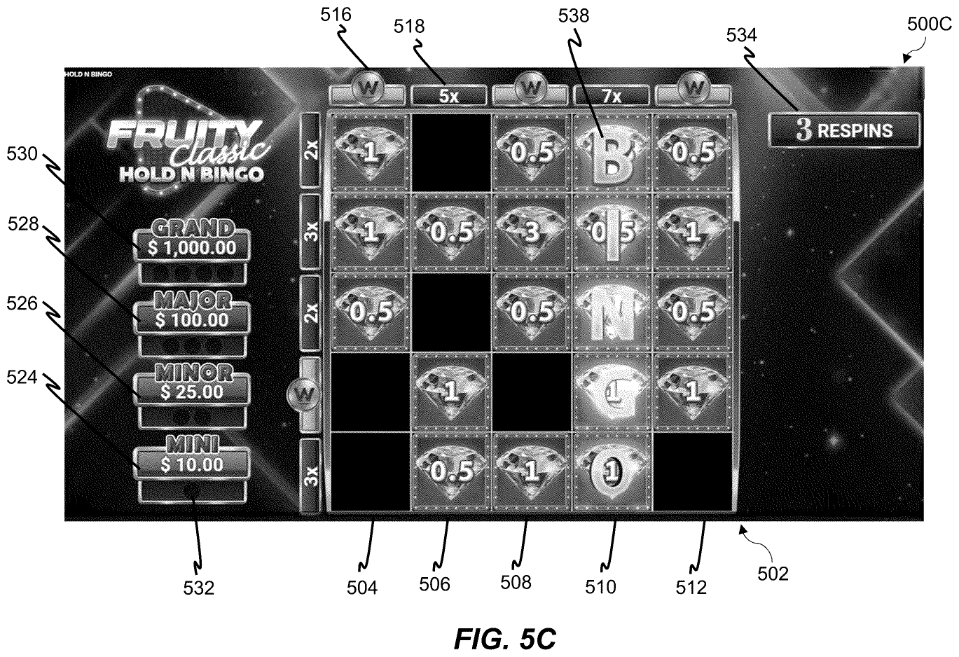

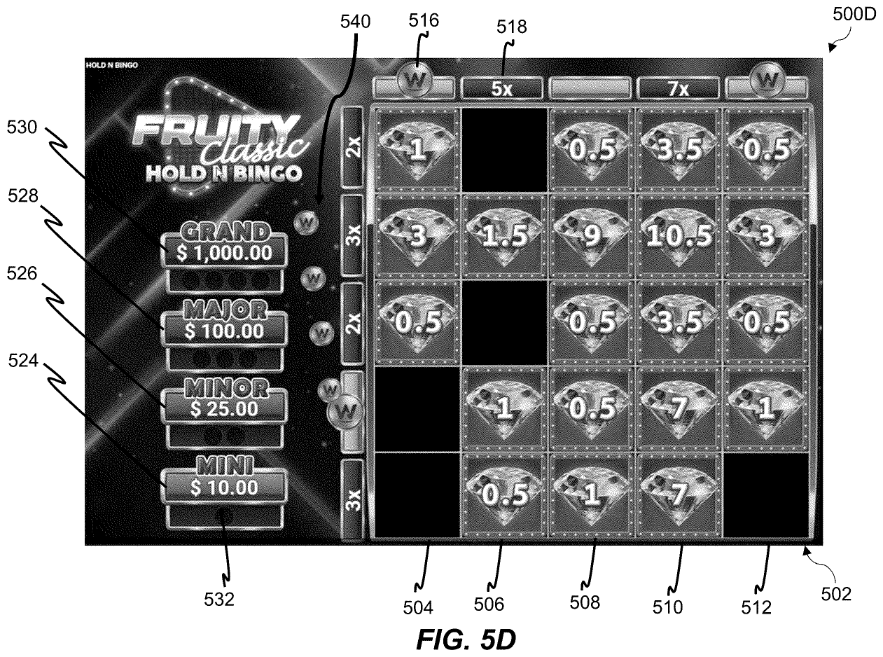

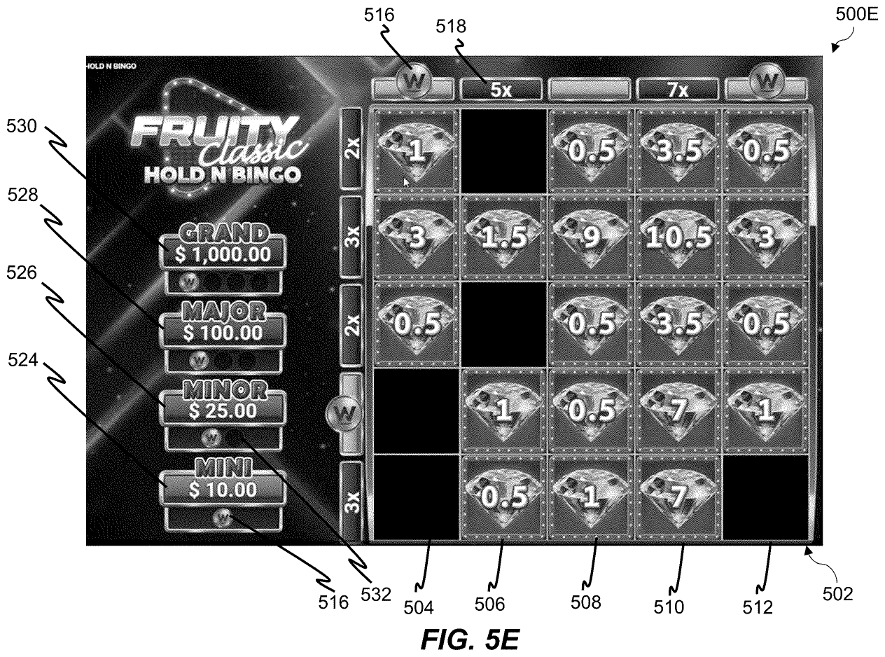

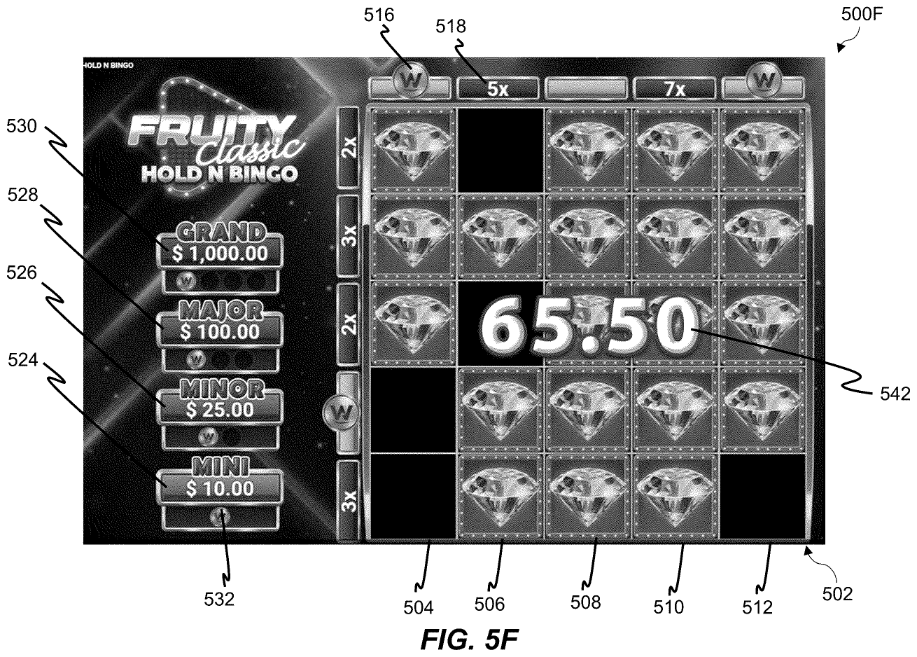

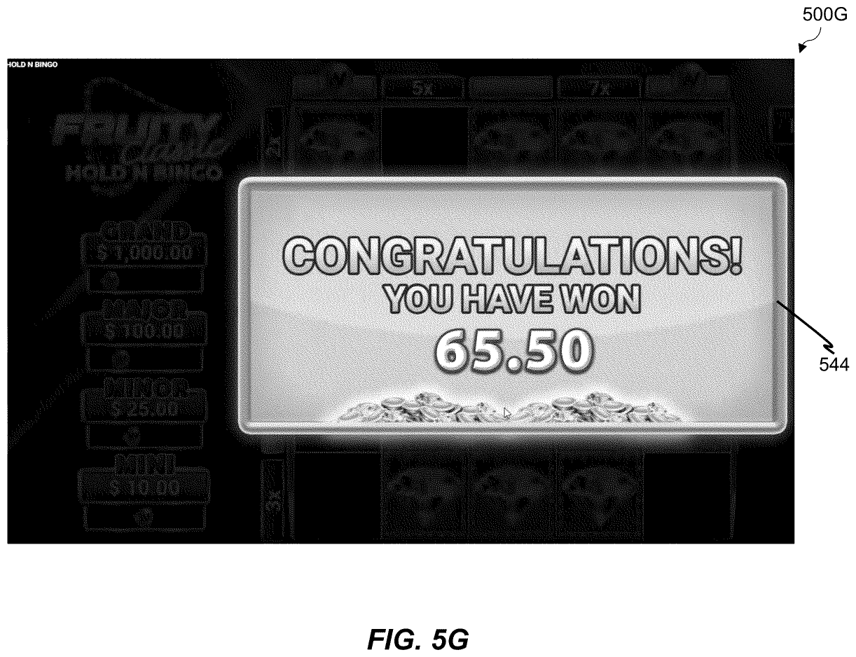

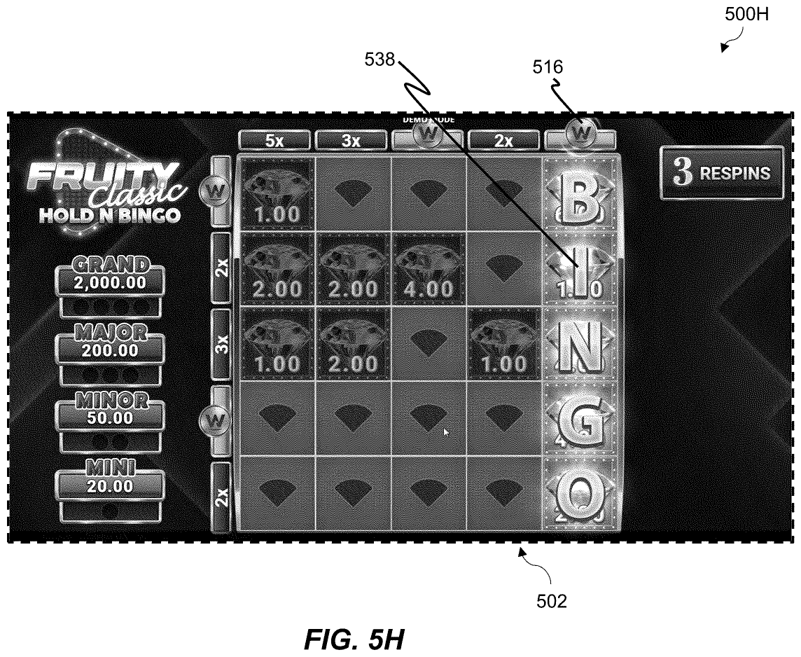

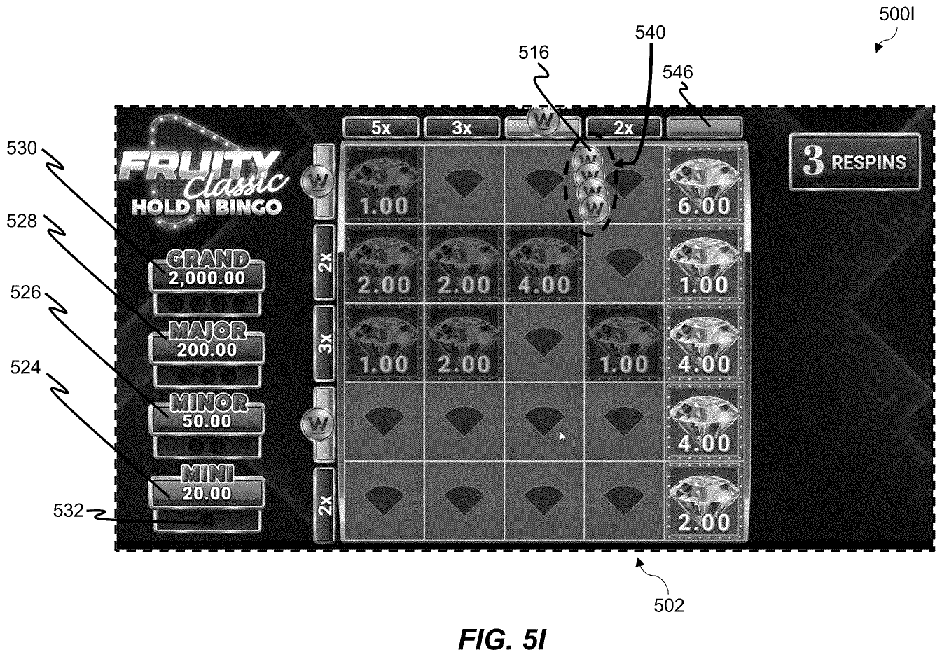

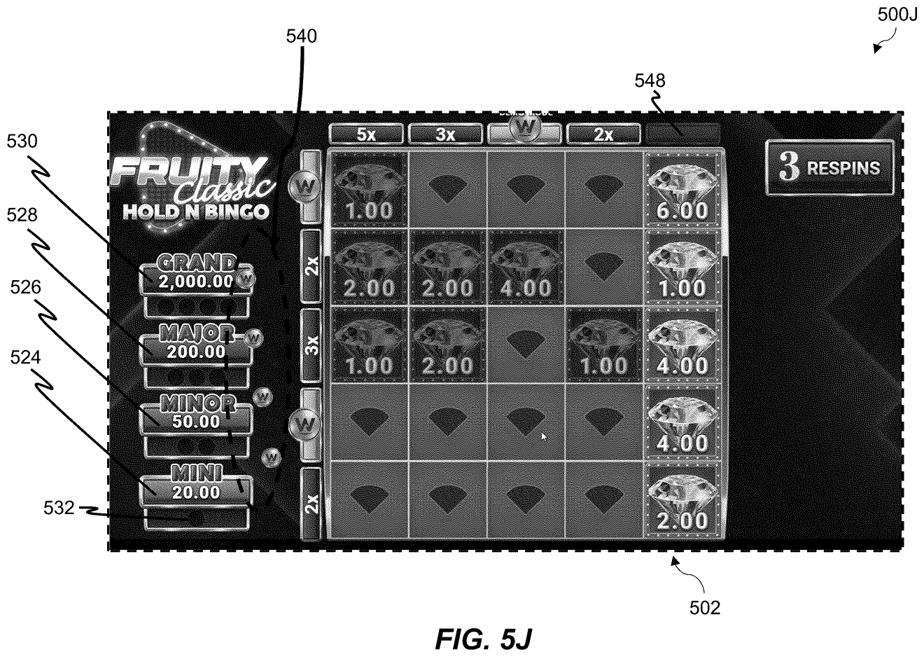

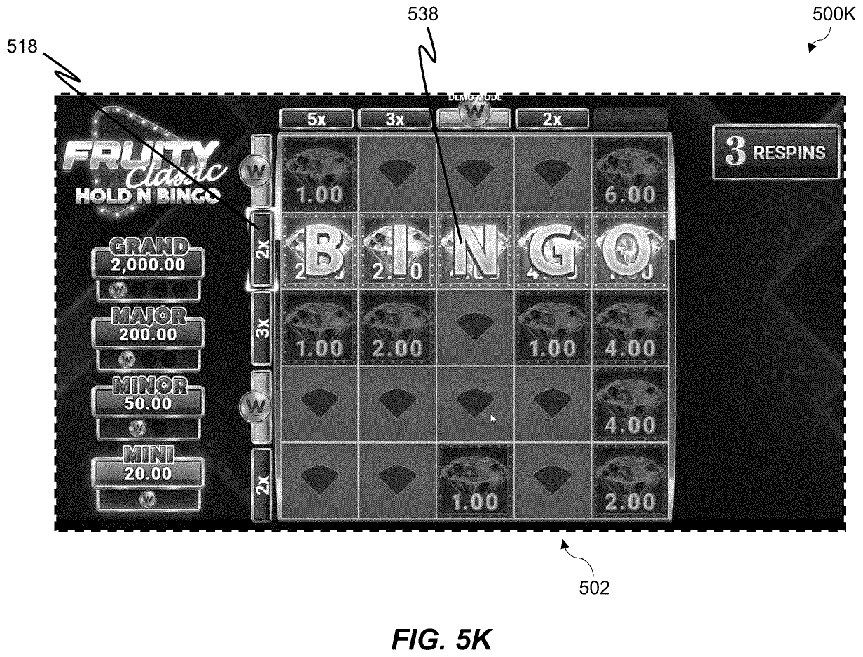

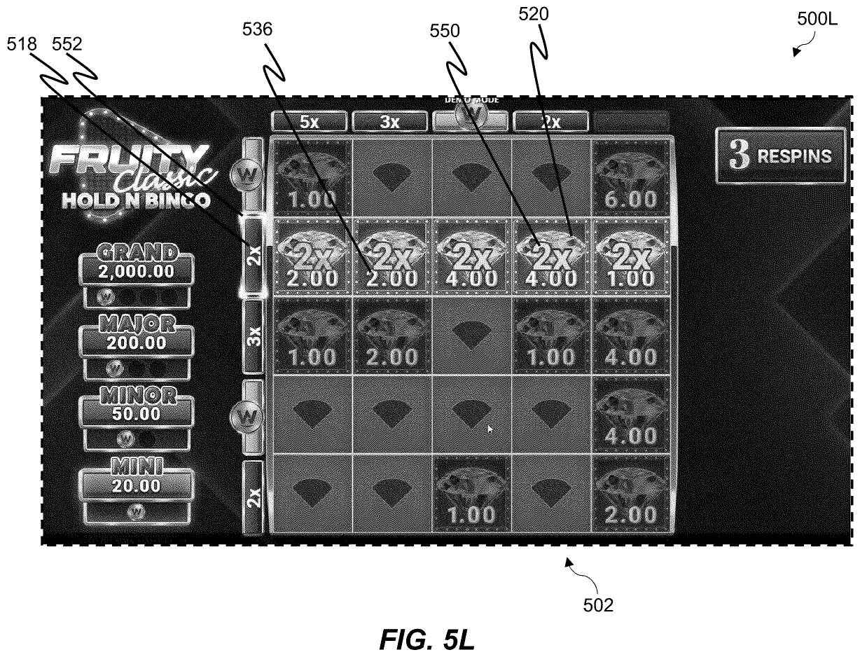

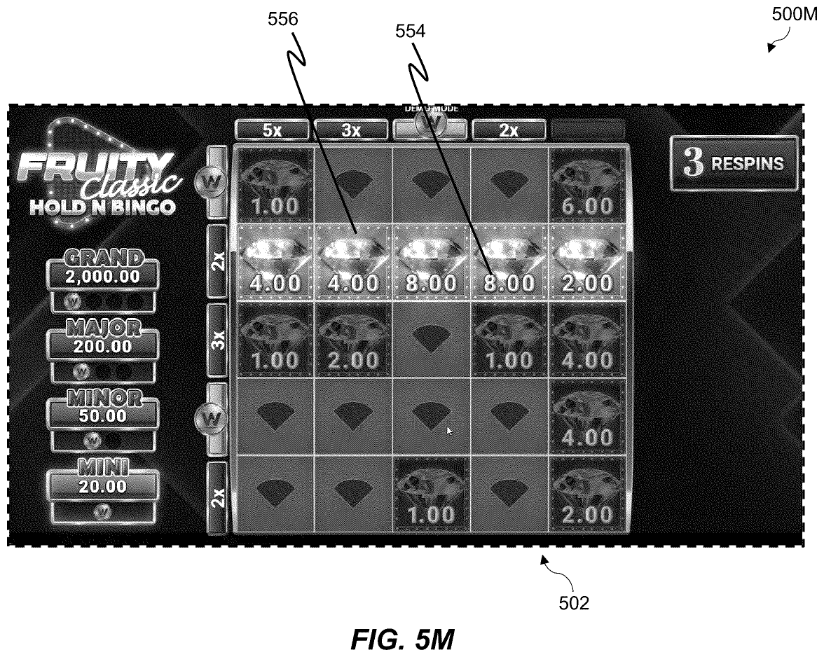

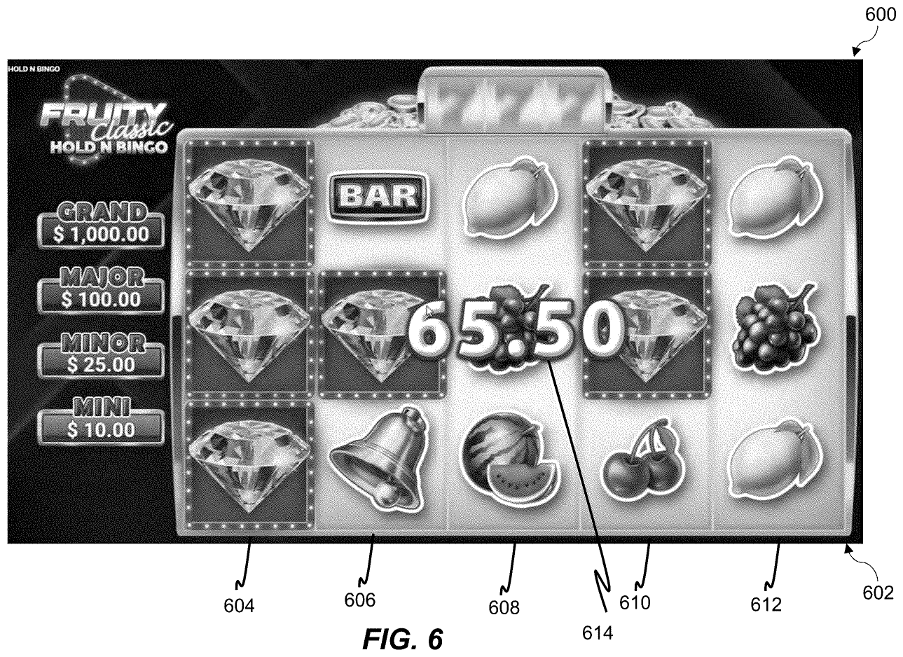

FIGS. 4A, 4B, 5A-5G, and 6 illustrate screenshots and/or interfaces of a base game (e.g., FIGS. 4A, 4B, 6) as well as of a hold and spin feature game (e.g., FIGS. 5A-5G) that may be provided and displayed on mobile gaming devices 256 and/or EUDs 264a, 264b and 264c, as described herein. FIGS. 4A, 4B, 5A-5G, and 6 may be viewed both from an individual standpoint as well as a sequential standpoint, where FIGS. 4A, 4B, 5A, 5B, 5C, 5D, 5E, 5F, 5G, and 6 are in a sequential order with the interface shown in FIG. 4A being “first” in the sequence and the interface shown in FIG. 6 being “last” in the sequence. However, this is not limiting, and other interfaces, visual graphics, animations, transitions, and the like may occur and/or appear in between and/or in conjunction with the interfaces shown in FIGS. 4A, 4B, 5A, 5B, 5C, 5D, 5E, 5F, 5G, and 6.

FIG. 4A illustrates a screenshot and/or interface 400A of a base game from which a hold and spin feature (e.g., a hold and spin bingo feature) may be activated, and that may be provided and displayed on mobile gaming devices 256 and/or EUDs 264a, 264b and 264c, as described herein. In the exemplary embodiment, the base game includes the ability to trigger a hold and spin feature game that includes a hold and spin feature (e.g., where a certain combination of symbols that land cause certain reels or certain positions within the reels of the reel set to hold while other reels/positions within reels continue to spin and land additional symbols in the successive spins) by landing a certain combination and/or amount of designated symbols (e.g., trigger symbols) in a symbol matrix of the base game.

As shown by interface 400A, the base game may include symbol matrix of a certain size, such as a 3×5 symbol matrix 402 including three rows and five columns (this configuration is not limiting, and other combinations of rows and columns may be implemented within the base game). The columns may correspond to reels 404, 406, 408, 410, and 412, where reels 404 to 412 may be referred to collectively as a reel set. The rows and columns of symbol matrix may include a certain amount of symbol positions 414, such as an amount that corresponds to the number of rows and columns. For example, in a 3×5 matrix, there may be fifteen symbol positions 414, illustrated by example symbol position 414 as shown in FIG. 4A. Symbol positions 414 may be filled by standard symbols 416, special symbols 418 (e.g., symbols such as “Wild” symbols, “7” symbols, etc. that have special functionality), and/or other designated symbols such as trigger symbols (e.g., such as symbols 420 shown in FIG. 4B) that may, in certain combinations and/or amounts, trigger an event to occur within the base game. Standard symbols 416 may, for example, include graphics/icons that are consistent with a theme of the game, including but not limited to a fruit theme. For example, standard symbols 416 may include a lemon symbol, a grapes symbol, a cherries symbol, a plum symbol, and a watermelon symbol. Special symbols 418 may, for example, include graphics/icons that are consistent with special symbols that have special functionality such as a “Wild” symbol, a “7” symbol, a “BAR” symbol, and/or combinations thereof, without limitation. Special symbols 418 may also include symbols such as a clover symbol, a horseshoe symbol, and a bell symbol. For example, a “Wild” symbol may function to substitute for other symbols to create a winning combination of symbols, one or more “7” symbols may provide a combination of symbols that result in elevated win levels, and a “BAR” symbol may have single, double, or triple bars associated with different win levels. Additionally, or in the alternative, certain standard symbols 416 such as cherries may have special functionality such as triggering a win even if only one or two cherries appear on a given line, whereas the other standard symbols may require a set of three or more to trigger a win. The determination of each symbol that lands within symbol matrix 402 may be based on a reference to a lookup table and an RNG call as described herein. The term “target symbol” as used herein may be used to reference one or both of special symbols 418 and trigger symbols 420, and/or combinations thereof.

The hold and spin feature game may be triggered by landing a threshold combination and/or threshold amount of designated symbols such as trigger symbols within a given spin of the base game, where such designated symbols may include credit symbols such as cash on reel (COR) symbols and/or other various credit symbols (e.g., a target/trigger symbol 420 that lands in the base game may include a corresponding credit value in the feature game, such as shown in FIG. 5B by target/trigger symbol 520 and credit value 522). If a hold and spin feature game is triggered via the landing of a threshold combination and/or threshold amount of trigger symbols, upon the start of the hold and spin feature game, the trigger symbols that landed in the base game may be held in the symbol position they occupied within symbol matrix 402 of the base game. Regarding the symbol positions within the symbol matrix other than the symbol positions occupied by held trigger symbols, in the exemplary embodiment, such un-held symbol positions may be changed to being blank/empty, to be filled with additional trigger symbols upon the playing of spins in the hold and spin feature game without the use of any associated reel strips for the various un-held symbol positions. The landing spot of the additional trigger symbols may be determined by reference to a lookup table as part of mapping a result of an RNG call, as well as any related process operations such as performed by process control module 324, where the blank/empty spot or spots are populated with a determined trigger symbol or trigger symbols, such that the additional trigger symbol or symbols visually appear in an un-held spot during spins of the hold and spin feature game. In other words, in certain embodiments, the additional trigger symbol or symbols are not associated with a graphic showing spinning of a reel strip for each given un-held symbol position. Rather, the additional trigger symbol or symbols simply appear within a given symbol position or positions. The landing spot of any additional trigger symbols in the hold and spin feature game may be utilized in conjunction with determining wins in association with a bingo gameplay aspect of the hold and spin feature game, described herein.

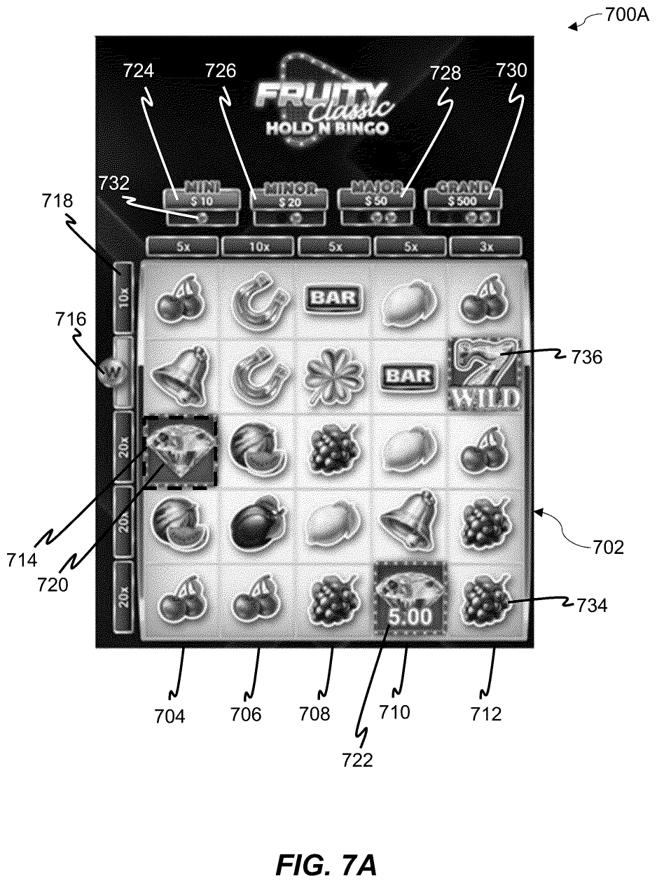

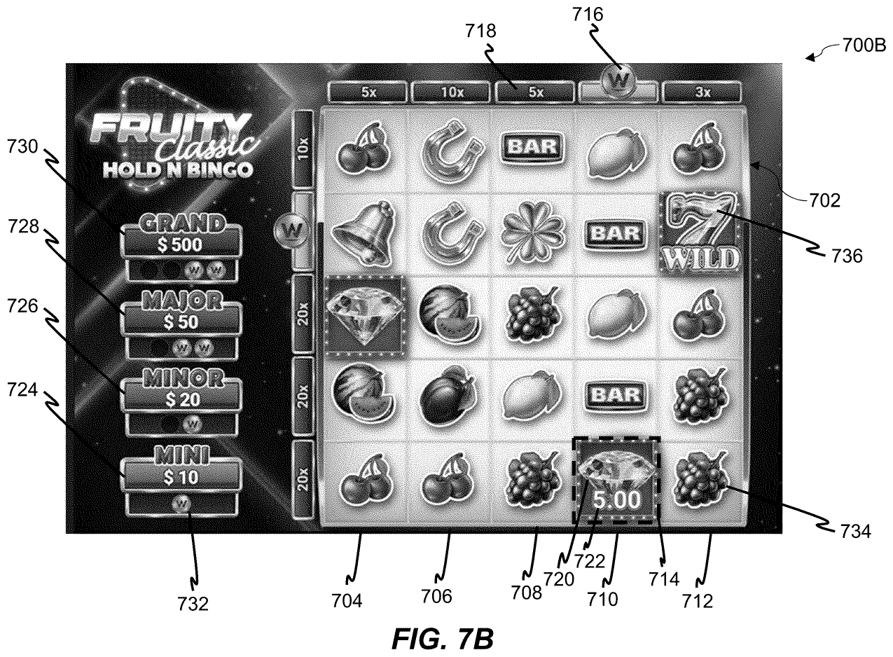

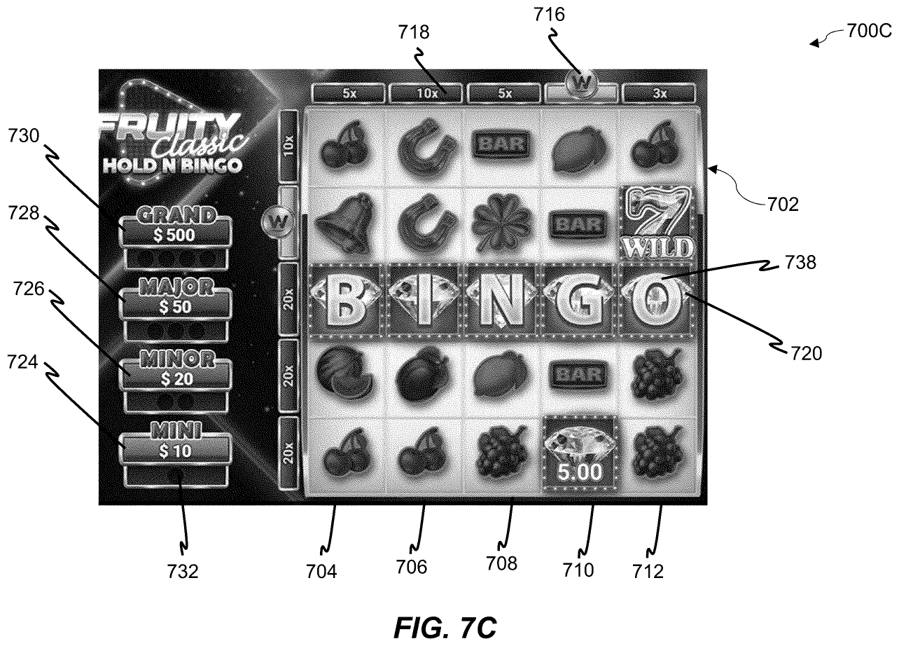

In other embodiments, the un-held symbol positions may be populated by an RNG call in connection with an associated reel strip of a given un-held symbol position in the hold and spin feature game. In such other embodiments, the un-held symbol positions may be filled based on the use of reel strips associated with such un-held symbol positions. Symbol positions 414 within reels 404 to 412 that were not held with trigger symbols as part of the hold and spin feature may land a different symbol via subsequent reel spins in the hold and spin feature game. To this end, FIGS. 7A-7C illustrate an alternative embodiment.

The triggering of the hold and spin feature may occur on the reel set of the base game during a spin of the base game, and in some embodiments, on the reel set of other game types such as a bonus or feature game, as described herein.

FIG. 4B illustrates a screenshot and/or interface 400B of a base game including landed trigger symbols 420 in symbol positions 414 in connection with the hold and spin feature that may be provided and displayed on mobile gaming devices 256 and/or EUDs 264a, 264b and 264c, as described herein. As shown in FIG. 4B, a plurality of trigger symbols 420 have landed on various reels of the reel set, including on reels 404, 406, and 410. Trigger symbols 420 may include a graphic/icon such as a diamond or other gem and/or other associated graphics such as a colored background, borders, etc. to provide visual emphasis of their special status relative to other symbols. Landing a certain amount of trigger symbols 420 may trigger a feature game that may include a hold and spin feature game. In the exemplary embodiment, a threshold amount of trigger symbols 420 is required to trigger the hold and spin feature game. For example, and without limitation, the threshold amount may include six or more trigger symbols 420, where landing six or more total trigger symbols 420 in any six symbol positions 414 in the base game reel set may trigger the hold and spin feature game. Trigger symbol 420 may include any variety of symbols, including but not limited to a diamond symbol. Trigger symbol 420 may also function as a credit symbol and have an associated values from a plurality of values, such as a COR or other credit value. For example, trigger symbol 420 may have a value of 5.00 credits, 10.00 credits, and so on and so forth for awarding of credits that correspond to the value shown in association with the credit symbol. Thus, individual trigger symbols may have their own associated value, but then also function to trigger the hold and spin feature game if enough trigger symbols 420 land.

FIGS. 4A and 4B may be viewed individually as separate interfaces and/or in sequence (e.g., where interface 400B of FIG. 4B is subsequent to interface 400A of FIG. 4A). In other words, FIGS. 4A and 4B may be treated as being in sequential order, although intervening interfaces, transitions, and/or other graphics may appear in between the interfaces of FIGS. 4A and 4B.

FIG. 5A illustrates a screenshot and/or interface 500A of a hold and spin feature game such as a hold and spin bingo feature game that may be provided and displayed on mobile gaming devices 256 and/or EUDs 264a, 264b and 264c, as described herein. The hold and spin feature game may include a symbol matrix 502. After the landing of the threshold amount of trigger symbols 420 as shown in FIG. 4B, thereby triggering the hold and spin feature game, the hold and spin feature game begins. At the onset of the hold and spin feature game, trigger symbols 420 from symbol matrix 402 of the base game may carry over into matching positions in symbol matrix 502 of the hold and spin feature game. Additionally, a threshold number of additional rows and/or columns may be added to the 3×5 symbol matrix 402 of the base game. In the exemplary embodiment, two extra rows are added at the bottom of the 3×5 symbol matrix 402 of the base game such that symbol matrix 502 of the hold and spin feature game is a 5×5 symbol matrix 502 having five rows and five columns. The transition from the 3×5 matrix to the 5×5 matrix may include, without limitation, various animations such as fade (e.g., fade to black) animations, and/or animations showing expansion of the 3×5 matrix into a 5×5 matrix. Each column may correspond to a reel 504, 506, 508, 510, and 512, and there may be twenty-five symbol positions 514 within the reel set. In the example shown in FIG. 5A, because six filled positions were carried over from the landed trigger symbols 420 of the base game, the other nineteen symbol positions 514 of symbol matrix 502 may be left blank, to be filled with additional (e.g., credit) symbols during play of the hold and spin feature game.

Interface 500A of the hold and spin feature game may also include various other gameplay aspects including special features such as tokens 516 and multipliers 518. Tokens 516 may be associated with a corresponding row or column of symbol matrix 502 and in connection with one or more jackpots 524, 526, 528, and 530 that may be winnable in the hold and spin feature game. Jackpot 524 may be a MINI jackpot, jackpot 526 may be a MINOR jackpot, jackpot 528 may be a MAJOR jackpot, and jackpot 530 may be a GRAND jackpot. Tokens 516 may also be referred to herein as jackpot tokens. As shown in interface 500A of FIG. 5A, an initial outcome of the hold and spin feature game may result in the first, third, and fifth columns associated with reel 504, reel 508, and reel 512, respectively, including a jackpot token 516. Additionally, the outcome may result in a row (e.g., the fourth row from the top of symbol matrix 502 or alternatively the second row from the bottom of symbol matrix 502 if viewed from the opposite direction) including a jackpot token 516. As further shown in FIG. 5A, the outcome may result in the second and fourth columns associated with reel 506 and reel 510, respectively, including a multiplier (e.g., a 5× multiplier for the second column and a 7× multiplier for the fourth column). Additionally, the outcome may result in the first, second, third, and fifth rows of symbol matrix 502 including respective multipliers 518 (e.g., a 2× multiplier for the first row, a 3× multiplier for the second row, a 2× multiplier for the third row, and a 3× multiplier for the fifth row). Icons associated with jackpots 524, 526, 528, and 530 may each include one or more token landing spots 532 for tokens 516 upon distribution of any awarded tokens, described in more detail herein. Landing spots 532 may display, once filled, a symbol of a jackpot token 516 upon distribution of jackpots tokens 516 to provide a visual indication to a player as to which jackpots 524-530 are in play.

In the exemplary embodiment, jackpot tokens 516 may be represented by a gold “W” coin symbol. Other graphics may be used to represent tokens 516. Additionally, each of the graphics of the tokens and multiplier prizes may be located within the interface on top of and/or on the side of rows and columns of the symbol matrix, although other locations are envisioned.

FIG. 5B illustrates a screenshot and/or interface 500B of a hold and spin feature game such as a hold and spin bingo feature game that may be provided and displayed on mobile gaming devices 256 and/or EUDs 264a, 264b and 264c, as described herein. Compared to interface 500A and the six trigger symbols 420 that triggered the hold and spin feature game, interface 500B includes a new additional trigger symbol 520 at symbol position 514 in the fourth row/fourth column, so that seven total trigger symbols 420/520 are present within symbol matrix 502, which includes a mix of prior trigger symbols (e.g., from the base game) and new trigger symbols (e.g., from the hold and spin feature game). Credit values 522 of the prior trigger symbols 420 may displayed as part of symbol graphics. In the exemplary embodiment, a pre-requisite amount of spins may be provided at the start of the hold and spin feature game and after each landing of a new trigger symbol/symbols in any given spin within the hold and spin feature game. A spin indicator 534 may be provided to indicate a number of remaining spins to the player. The pre-requisite number of spins may be three spins. During play of the hold and spin feature game, each landing of a new trigger symbol (or simultaneously landed trigger symbols) may reset the amount of spins shown in spin indicator 534 to the pre-requisite amount of spins, which are then spun down until exhausted or until the landing of a new trigger symbol/symbols that resets the available amount of spins to the pre-requisite amount of spins. In other embodiments, the pre-requisite number of spins may be more or less than three.

Additionally, as shown in interface 500B, each new trigger symbol (as well as the prior landed trigger symbols that triggered the hold and spin feature game) have an associated value 536 that has been determined, for example, by reference to a lookup table. Values 536 of trigger symbols 520 may be values that are the same as or similar to values 522 of trigger symbols 420. For example, values 536 may be determined from the same lookup table as values 522, or via separate lookup specially designated for trigger symbol values for trigger symbols that land as part of the hold and spin feature game.

FIG. 5C illustrates a screenshot and/or interface 500C of a hold and spin feature game such as a hold and spin bingo feature game that may be provided and displayed on mobile gaming devices 256 and/or EUDs 264a, 264b and 264c, as described herein. Interface 500C illustrates the landing of additional trigger symbols (e.g., new diamond symbols such as diamond symbols 520) within symbol matrix 502. As more and more trigger symbols land via spins in the hold and spin feature game, the various rows and columns within symbol matrix 502 begin to fill. When a full line of trigger symbols in any given row or column land, a win graphic 538 may displayed. In the exemplary embodiment, win graphic 538 overlays the letters of the word “BINGO” on the respective winning trigger symbols, e.g., “B” on the first symbol of five winning symbols in a given row or column, “I” on the second symbol of five winning symbols in a given row or column, and so on and so forth such that “BINGO” appears across the entire row or column such as illustrated in FIG. 5C. Tokens 516 may be awarded from achieving a bingo in a row or column that has an associated token 516. For example, in FIG. 5C, each of the first, third, and fifth columns and the fourth row of symbol matrix 502 includes an associated token 516. If a player achieves a bingo in any of these columns or rows, the player will be awarded a corresponding token 516, as explained in more detail in connection with FIG. 5D. Similarly, if a player achieves a bingo in a column or row with a multiplier 518, the player will be awarded with the corresponding multiplier. For example, in FIG. 5C, each of the second and third columns and first, second, third, and fifth rows have associated multipliers 518. The winning bingo shown in the fourth column will result in the corresponding 7× multiplier being applied to the values of the trigger symbols (e.g., 420/520) that resulted in the bingo when the total wins are determined at the conclusion of the hold and spin feature game. FIGS. 5A to 5C may be representative of a symbol filling processing stage of the game processing pipeline.

FIG. 5D illustrates a screenshot and/or interface 500D of a hold and spin feature game such as a hold and spin bingo feature game that may be provided and displayed on mobile gaming devices 256 and/or EUDs 264a, 264b and 264c, as described herein. Interface 500D illustrates all spins of the hold and spin feature game being exhausted and a tallying of the wins from the play of the hold and spin feature game. For example, compared to interface 500C in FIG. 5C, interface 500D includes additional landed trigger symbols (e.g., diamond symbols 420) including a full column at the third column of symbol matrix 502, resulting in a bingo at the third column. As the third column was associated with a token 516, FIG. 5D illustrates jackpot tokens corresponding to won token 516 being distributed to landing spots 532 of the various jackpots 524, 526, 528, and 530. As shown, interface 500D illustrates a visual graphic 540 representing the transfer of jackpot tokens 516 from the respective rows/columns from which they were awarded to respective landing spots 532.

FIG. 5E illustrates a screenshot and/or interface 500E of a hold and spin feature game such as a hold and spin bingo feature game that may be provided and displayed on mobile gaming devices 256 and/or EUDs 264a, 264b and 264c, as described herein. With reference to FIGS. 5C and 5D, because only one token 516 was won, only the first landing spot 532 of each jackpots 524, 526, 528, and 530 are filled with a token symbol. In FIG. 5E, the first and only landing spot 532 of the MINI jackpot 524 has been filled, and the player will be awarded the MINI jackpot 524 at the conclusion of the hold and spin feature game. The other jackpots 526, 528, and 530 were not unlocked because all of their landing spots 532 were not filled with tokens. For example, as shown in FIG. 5E, jackpot 530 may require 4 tokens to win the jackpot, jackpot 528 may require 3 tokens to win the jackpot, jackpot 526 may require 2 tokens to win the jackpot, and jackpot 524 may require 1 token to win the jackpot. In the exemplary embodiment, only the highest achieved jackpot will be awarded. For example, if a player wins a bingo in four total rows and columns that each have a corresponding token 516, the four winning tokens 516 will be transferred to landing spots 532 as shown in FIG. 5D, and the GRAND jackpot 530 will have all of its landing spots 532 filled. The lower MAJOR, MINOR, and MINI jackpots will have also necessarily been filled by the winning of four tokens, but only the highest jackpot, e.g., the GRAND jackpot in this case, will be awarded. This is just one implementation of how to award jackpots and is not limiting, as other jackpot awarding schemes are envisioned.

The various control elements 326A to 326H of process control module 324 may be implemented to generate the outcomes shown in FIGS. 5A-5E as follows. With reference to FIG. 5A, placement selector 326D may be programmed to carry over the position locations of trigger symbols 420 from the matrix of the base game (as shown in FIG. 4B) to corresponding positions in the matrix of the feature game (although in some embodiments the positions of trigger symbols 420 from the base game may be randomly assigned to new positions in the feature game matrix by random re-assignment that populates the new positions with trigger symbols matching the number of trigger symbols 420 from the base game). Placement selector 326D may also be programmed to place tokens 516 and multipliers 518 in association with the rows and columns of the feature game matrix as shown in FIG. 5A. This may be performed in conjunction with an RNG pull and reference to corresponding lookup table for tokens and multipliers (such as shown in FIGS. 12B and 12C). The placement of the tokens and multipliers may be performed in association with outputs from token selector 326F and prize selector 326G and in view of the lookup table results. Pattern selector 326A may be programmed to determine a minimum number of winning bingo lines in conjunction with an output from rate regulator 326B. This may be performed in conjunction with an RNG pull and reference to corresponding lookup table for winning patterns (such as shown in FIG. 12A).

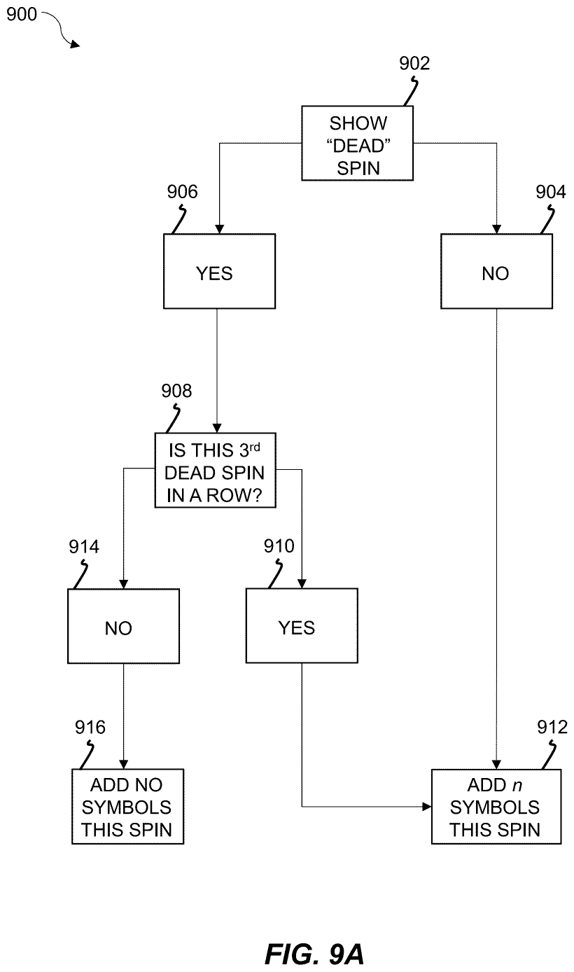

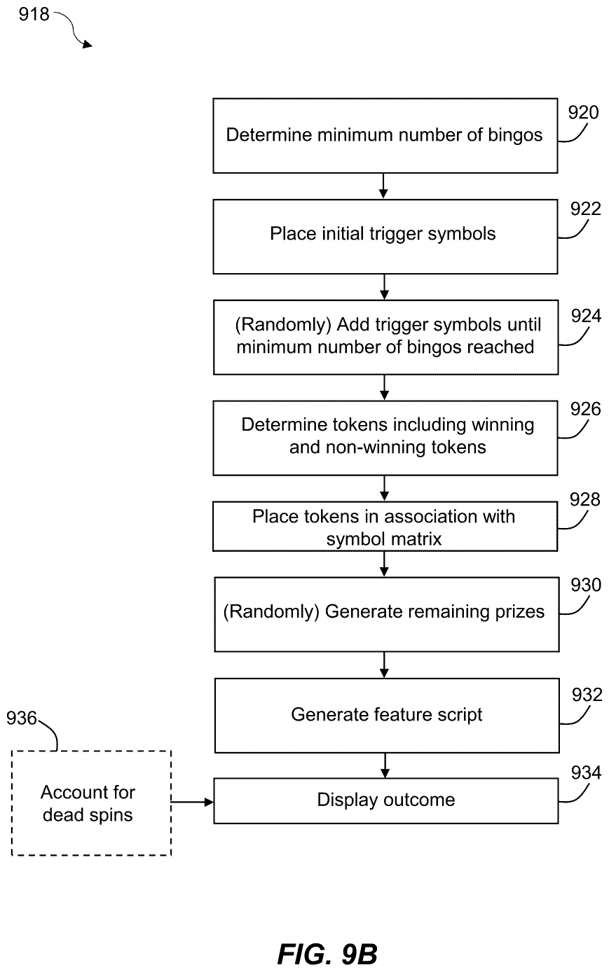

Symbol selector 326E may be programmed to select additional trigger symbols 520 as shown in FIGS. 5B and 5C to satisfy the minimum patterns result of pattern selector 326A and/or rate regulator 326B, where such symbols may be placed based on one or more outputs from placement selector 326D. Script generator 326H may be programmed to cause visual display of the feature game outcome based on winning pattern and selection and distribution of trigger symbols 520, tokens 516, and multipliers 518. This may include control of visuals such as win graphic 538 and token win graphic 540 (also shown in FIGS. 5I and 5J) conveying the transfer of awarded tokens to corresponding jackpots 524-530 as well as visual display of the awarding credit values of trigger symbols in winning rows/columns being increased by the awarded multiplier (e.g., such as the 3× winning row as shown in FIGS. 5C to 5D, see also FIGS. 5K to 5M). This may also include placement selector 326D being programmed to control placement of awarded tokens 516 to corresponding landing spots 532 as shown in FIG. 5E. Dead spin counter 326C may operate during (or before) the operation of script generator 326H to further control the outcome of the feature game by controlling for dead spins as described herein such as in connection with FIG. 9A. Additional aspects of the operation of process control module 324 are described in connection with FIGS. 8A to 8C.

FIG. 5F illustrates a screenshot and/or interface 500F of a hold and spin feature game such as a hold and spin bingo feature game that may be provided and displayed on mobile gaming devices 256 and/or EUDs 264a, 264b and 264c, as described herein. FIG. 5F illustrates a win graphic 542 overlaid on interface 500E of FIG. 5E, where win graphic 542 represents the total amount won from the play of the hold and spin feature game. The total (e.g., 65.50) shown in win graphic 542 represents the total of any jackpots and the total of any trigger symbols and/or full rows or columns, as multiplied by any applicable multipliers 518.

FIG. 5G illustrates a screenshot and/or interface 500G of a hold and spin feature game such as a hold and spin bingo feature game that may be provided and displayed on mobile gaming devices 256 and/or EUDs 264a, 264b and 264c, as described herein. FIG. 5G illustrates a win graphic 544 overlaid on interface 500F of FIG. 5F, where win graphic 544 may be a banner or other graphic illustrating the amount won from the play of the hold and spin feature game. Interface 500F may be presented in a darkened state to highlight win graphic 544.

FIGS. 5A-5G may be viewed individually as separate interfaces and/or in sequence (e.g., where interface 500G of FIG. 5G is subsequent to interface 500F of FIG. 5F, interface 500F of FIG. 5F is subsequent to interface 500E of FIG. 5E, and so on and so forth. Additionally, interface 500A of FIG. 5A may be viewed as being subsequent to interface 400B of FIG. 4B. In other words, FIGS. 4A, 4B, 5A, 5B, 5C, 5D, 5E, 5F, and 5G may be treated as being in sequential order, although intervening interfaces, animation, transitions, and/or other graphics may appear in between the display of interfaces of FIGS. 4A, 4B, 5A, 5B, 5C, 5D, 5E, 5F, and 5G.

FIGS. 5H-5J illustrate screenshots and/or interfaces of a hold and spin feature game such as a hold and spin bingo feature game that may be provided and displayed on mobile gaming devices 256 and/or EUDs 264a, 264b and 264c, as described herein. More specifically, 5H-5J illustrate additional aspects of how a bingo win and corresponding distribution of a token is visually presented. As shown in FIG. 5H, screenshot and/or interface 500H illustrates a bingo win that has occurred in a column including a token 516, as illustrated by bingo win graphic 538. As shown in FIG. 5I, screenshot and/or interface 500I illustrates distribution of token 516 to landing spots 532 associated with the various jackpots 524-530. Graphic 540 illustrates four tokens 516 being transferred to landing spots 532, to populate a first empty landing spot 532 for each jackpot. Additionally, FIG. 5I shows the top portion of the column that had the bingo win shown in FIG. 5H no longer has a token 516 located at the top of the column. Instead, the token that was won via the bingo win shown in FIG. 5H is now displayed with a top portion that includes an alternative graphic 546, indicating that the column no longer includes a winnable token. Alternative graphic 546 may also change appearance (e.g., color) to provide visual indication to the player that the token that previously was associated with the column is no longer present. As shown in FIG. 5J, screenshot and/or interface 500J illustrates further distribution of token 516 to landing spots 532 associated with the various jackpots 524-530 via graphic 540. Graphic 540 illustrates four tokens 516 being transferred to landing spots 532, to populate a first empty landing spot 532 for each jackpot. Additionally, FIG. 5J shows the top portion of the column that had the bingo win shown in FIG. 5H no longer has a token 516 at the top. Instead, the token that was won via the bingo win shown in FIG. 5H is now displayed with a top portion that includes an alternative graphic 548, indicating that the column no longer includes a winnable token. Alternative graphic 548 may be similar to or the same as alternative graphic 546 shown in FIG. 5I. For example, alternative graphic 548 may have a darkened appearance (e.g., color) relative to alternative graphic 546 shown in FIG. 5I, to further indicate that the column no longer includes a winnable token. Graphic 540 may include tokens 516 travelling across the interface until each token lands in its corresponding landing spot 532 and the depositing of the tokens in the corresponding landing spots.

FIGS. 5H-5J may be viewed individually as separate interfaces and/or in sequence (e.g., where interface 500J of FIG. 5J is subsequent to interface 500I of FIG. 5I, and interface 500I of FIG. 5I is subsequent to interface 500H of FIG. 5H), although intervening interfaces, animation, transitions, and/or other graphics may appear in between the display of interfaces of FIGS. 5H-5J.

FIGS. 5K-5M illustrate screenshots and/or interfaces of a hold and spin feature game such as a hold and spin bingo feature game that may be provided and displayed on mobile gaming devices 256 and/or EUDs 264a, 264b and 264c, as described herein. More specifically, FIGS. 5K-5M illustrate additional aspects of how a bingo win and corresponding distribution of an awarded multiplier prize is visually presented. As shown in FIG. 5K, screenshot and/or interface 500K illustrates a bingo win that has occurred in a row including a multiplier 518, as illustrated by win graphic 538. As shown in FIG. 5L, screenshot and/or interface 500L illustrates distribution of multiplier 518 to values 536 (or 522) of trigger symbols 520 within the winning bingo row. Graphic 550 illustrates the value of the awarded multiplier 518 (e.g., “2×” for a 2× multiplier). Additionally, FIG. 5L shows graphic 552 illustrating the multiplier of the winning row as being activated during the distribution of the multiplier value to the trigger symbols. Graphic 552 may include a glowing border around the multiplier, for example. FIG. 5M illustrates multiplied values 554 resulting from the distribution of the awarded multiplier 518. For example, the values 536 (or 522) shown in FIG. 5L have been doubled by virtue of the distribution of the 2× multiplier. Graphics 556 such as a glowing effect may be displayed to provide visual indication of the multiplied values for the corresponding symbol.

FIGS. 5K-5M may be viewed individually as separate interfaces and/or in sequence (e.g., where interface 500M of FIG. 5M is subsequent to interface 500L of FIG. 5L, and interface 500L of FIG. 5L is subsequent to interface 500K of FIG. 5K), although intervening interfaces, animation, transitions, and/or other graphics may appear in between the display of interfaces of FIGS. 5K-5M. Additionally, FIGS. 5K-5M may be subsequent interfaces to those shown in FIGS. 5H-5J (e.g., representing a subsequent spin or play of the same hold and spin game shown in FIGS. 5H-5J.

FIG. 6 illustrates a screenshot and/or interface 600 of a result of the hold and spin feature game and a return to the base game that may be provided and displayed on mobile gaming devices 256 and/or EUDs 264a, 264b and 264c, as described herein. Interface 600 of FIG. 6 is generally the same as interface 400B of FIG. 4B except for an overlaid win graphic showing an amount won from the play of the hold and spin feature game. Interface 600 shows a 3×5 symbol matrix 602, where the columns may correspond to reels 604, 606, 608, 610, and 612. Win graphic 614 may be the same as or similar to win graphic 542 shown in FIG. 5F. Additionally, when comparing interface 400B with interface 600A, it is shown that the symbol matrix 602 is populated with the same symbols at the same positions as those in FIG. 4B. Interface 600 represents a return to the base game interface and landed symbols that triggered the play of the hold and spin feature game, except that win graphic 614 may be temporarily overlaid on the symbol matrix (e.g., win graphic may include a fade animation such that the text of win graphic 614 fades away within the span of a few seconds) and/or may disappear upon a new/next spin of the base game.

FIG. 6 may be viewed individually as separate interface and/or in sequence (e.g., where interface 600 is subsequent to interface 500G of FIG. 5G). In other words, FIGS. 4A, 4B, 5A, 5B, 5C, 5D, 5E, 5F, 5G, and 6 may be treated as being in sequential order, although intervening interfaces, transitions, and/or other graphics may appear in between the interfaces of FIGS. 4A, 4B, 5A, 5B, 5C, 5D, 5E, 5F, 5G, 6.

FIGS. 7A and 7B illustrates a screenshot and/or interface 700A and 700B, respectively, of an alternative embodiment of the hold and spin feature game that may be provided and displayed on mobile gaming devices 256 and/or EUDs 264a, 264b and 264c, as described herein. FIGS. 7A and 7B each illustrate a symbol matrix including rows and columns similar to or the same as that shown in FIG. 5A, for example. Symbol matrix 702 may include a plurality of rows and columns, where reels 704, 706, 708, 710, and 712 may be associated with the columns. Symbol matrix 702 may be a 5×5 matrix representing the 5×5 format of the hold and spin feature game. Symbol positions 714 indicate a given symbol position within symbol matrix 702, and the columns and rows may have associated tokens 716 and multipliers 718. A trigger symbol 720 may land in a given position 714 and include a credit value 722. Jackpots 724, 726, 728, and 730 may be winnable as a result of the hold and spin feature game, where jackpot 724 may be a MINI jackpot, jackpot 726 may be a MINOR jackpot, jackpot 728 may be a MAJOR jackpot, and jackpot 730 may be a GRAND jackpot. Each jackpot graphic may include a landing spot 732 that is filled with won tokens 716 in the event a bingo line win occurs at any column that includes an associated token 716. In contrast to the 5×5 matrix of the hold and spin feature game shown in FIG. 5A, the 5×5 symbol matrix 702 may include being populated with standard symbols 734 and special symbols 736, which may be similar to symbols 416 and 418 shown in FIG. 4A. FIG. 7A illustrates a portrait orientation where graphics associated with the various jackpots are located above the symbol matrix. FIG. 7B illustrates a landscape orientation of the same landed symbols as in FIG. 7A, where the landscape orientation is similar or the same as that shown in FIG. 5A. In the embodiment shown in FIGS. 7A and 7B, instead of the (e.g., non-triggering) symbol positions being changed to blank/empty symbol positions (see FIG. 5A) upon entry into the hold and spin feature game, the reel set of the embodiment in FIG. 7A may populate the 5×5 symbol matrix 702 with symbols determined by an RNG call and by way of a reel strip associated with each position.

FIG. 7C illustrates a screenshot and/or interface 700C of an alternative embodiment of the hold and spin feature game that may be provided and displayed on mobile gaming devices 256 and/or EUDs 264a, 264b and 264c, as described herein. FIG. 7C illustrates a bingo line win and associated win graphics 738 in connection with the embodiments shown in FIGS. 7A and/or 7B. In FIG. 7C, when the bingo line win lands, all credit values shown on the trigger/credit (e.g., diamond) symbols 720 are multiplied by 20× due to the 20× multiplier associated with row three of symbol matrix 702. As an example, if each trigger/credit symbol 720 diamond on the bingo line win is worth 5.00, then each trigger/credit symbol 720 will now be worth 100.00 based on the 20× multiplier.

Further regarding the embodiment shown and described in connection with FIGS. 7A-7C, even if a reel strip is utilized for symbol selection, a fake or facade reel strip may be displayed on the front-end to the player while a different reel strip that is not visible to the player may be used on the back-end. That is, the back-end reel strip may be the “real” reel strip that determines symbols, whereas the front-end reel strip may be a “false” reel strip that is not linked to any actual results. This technique may serve as an additional security measure to combat reverse engineering of games.

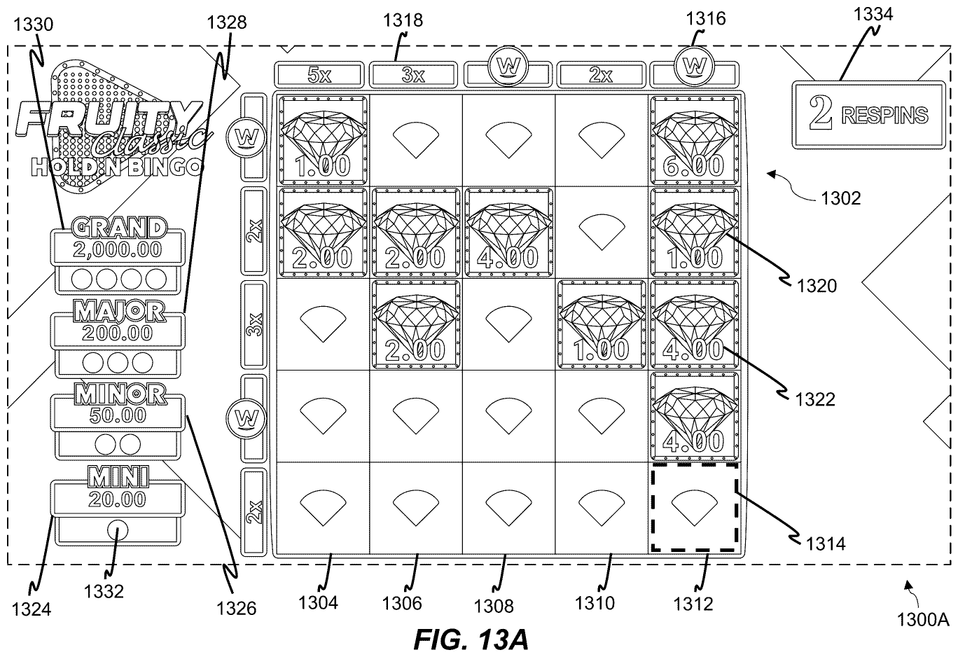

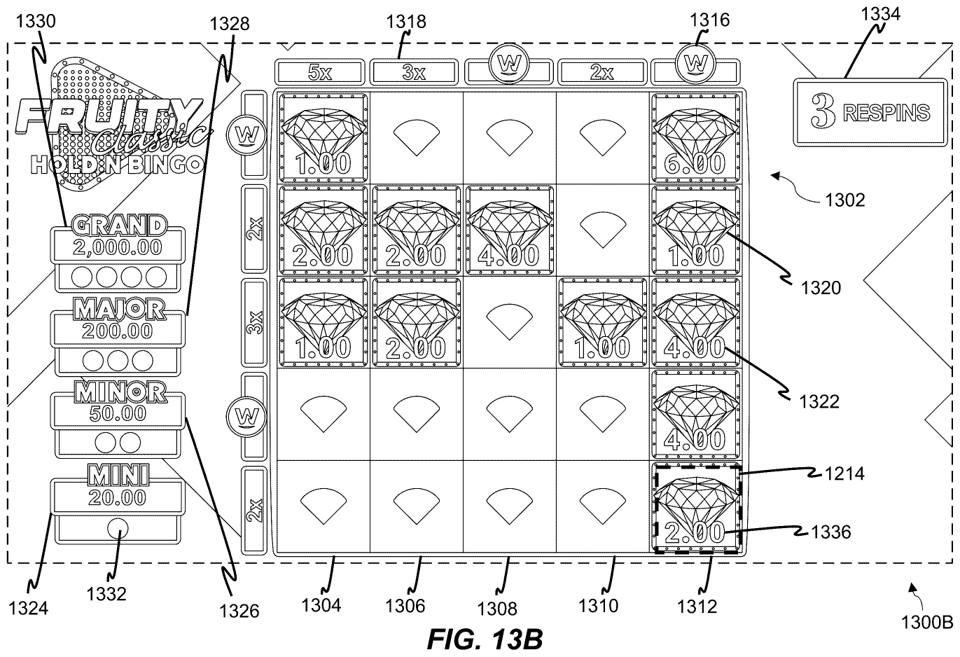

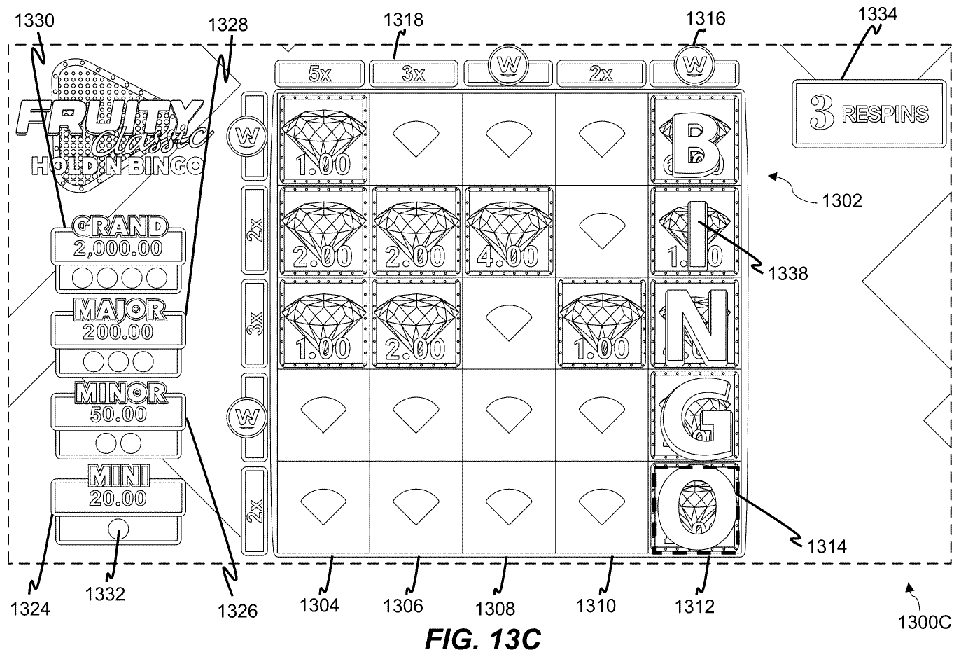

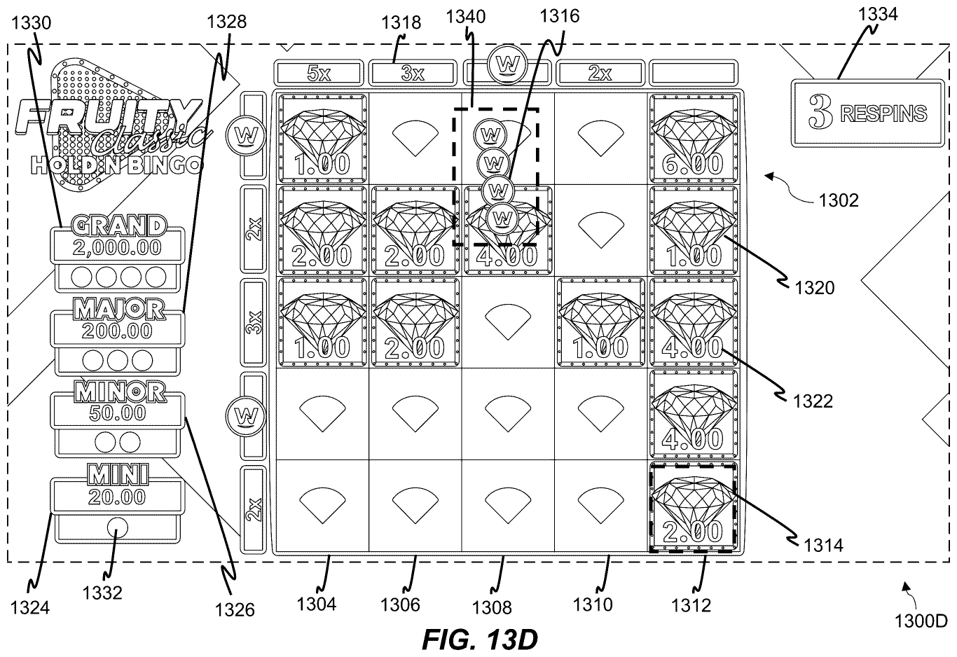

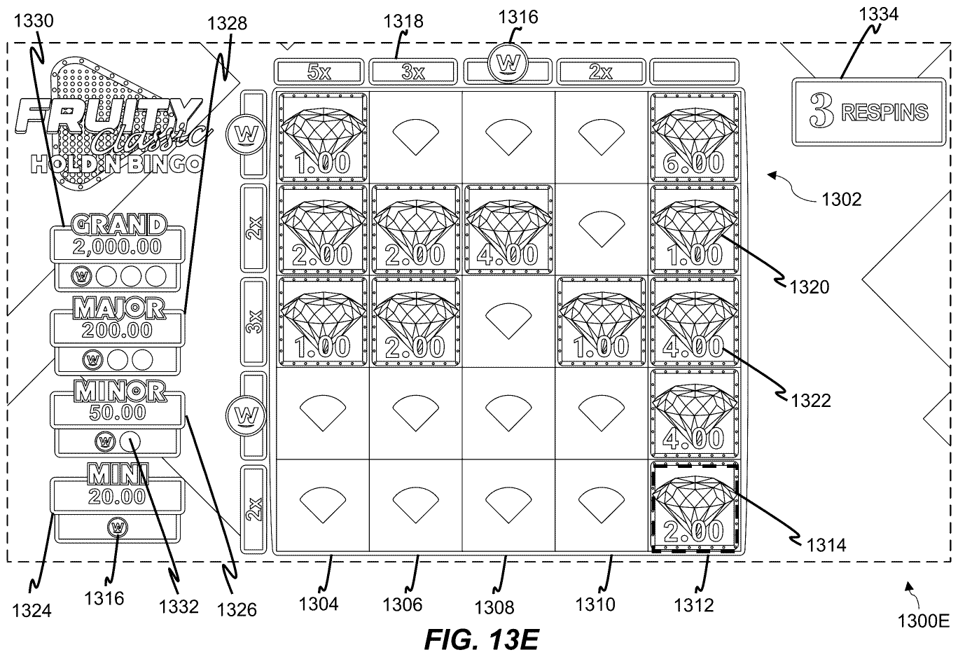

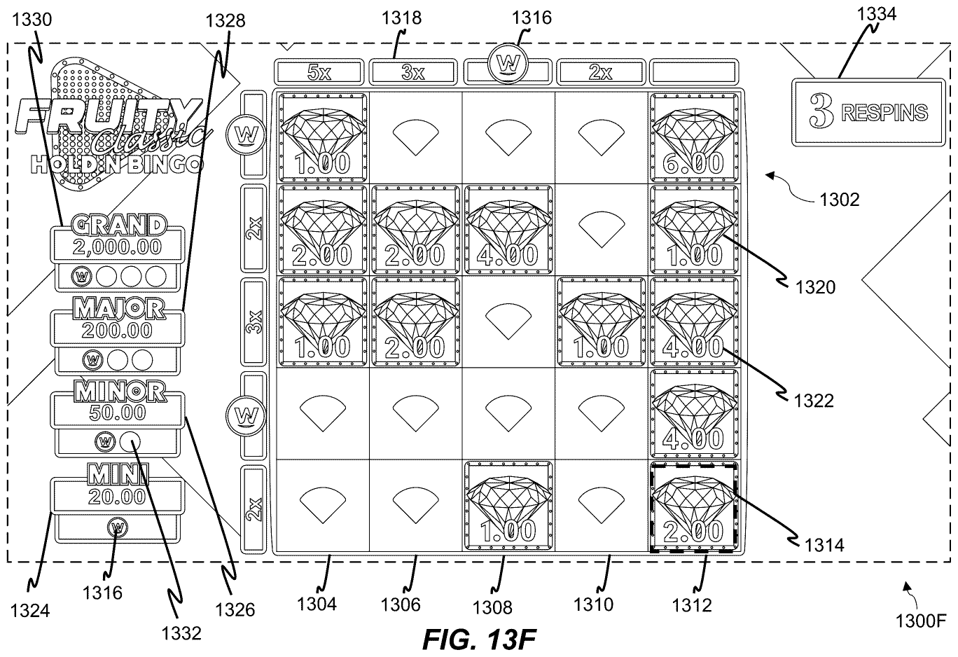

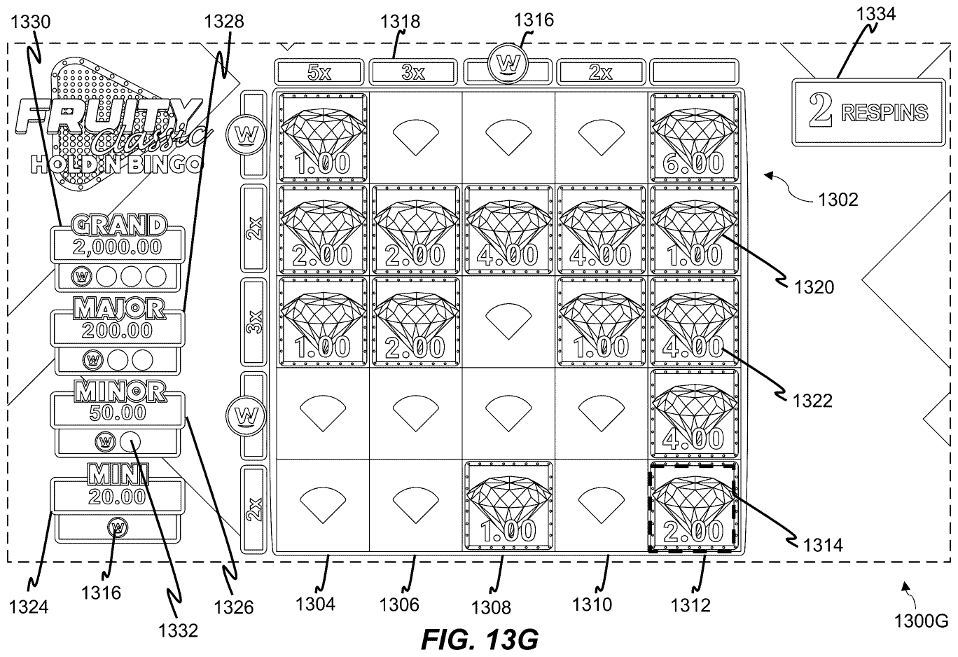

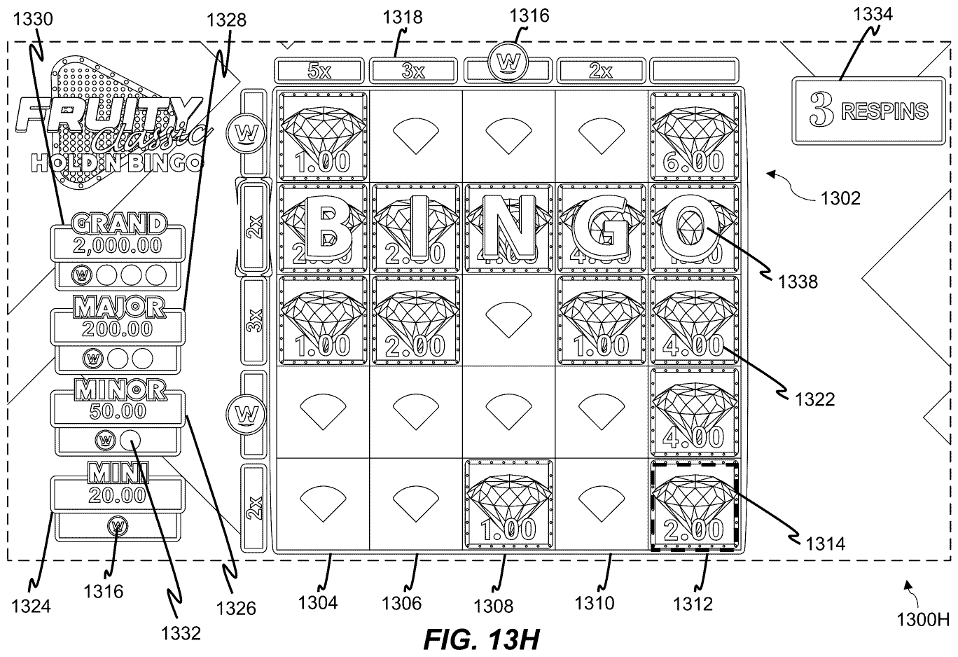

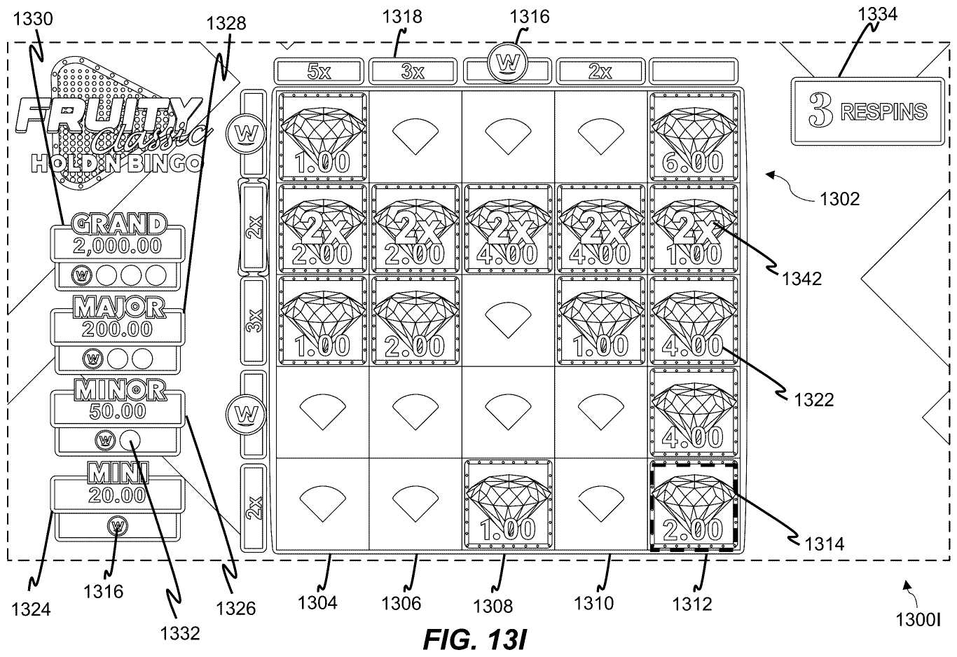

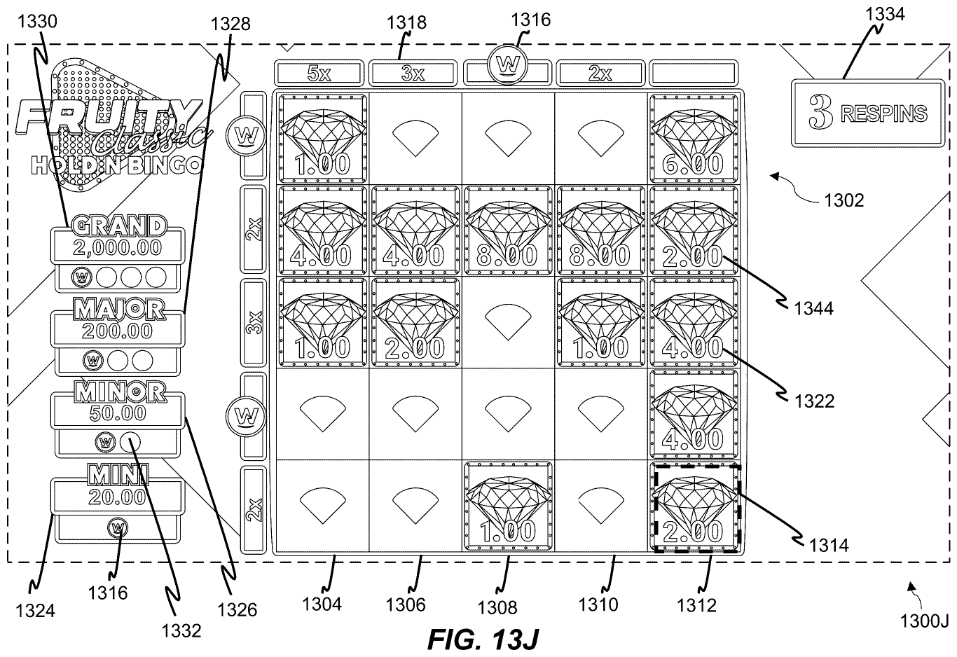

FIGS. 8A and 8B are diagrams illustrating the manner in which (i) trigger symbols (e.g., 420, 520 shown in FIGS. 4B and 5A-5E) are determined and placed in a symbol matrix (e.g., matrices 402 and 502), and (ii) tokens (e.g., 516 shown in FIG. 5A) and prizes (e.g., 518 shown in FIG. 5A) are determined and placed. FIGS. 8A and 8B may be representative of a symbol filling processing stage of the game processing pipeline, also represented in FIGS. 5A-5C and other related figures (e.g., FIGS. 13A-13J).

FIG. 8A illustrates a diagram 800 showing a population process of trigger symbols in the feature game symbol matrix according to one embodiment of the present disclosure, and such as shown in and described in connection with FIGS. 3, 4B and 5A-5E. For example, process control module 324 as shown in FIG. 3 may be implemented to populate trigger symbols as shown in FIG. 8A. Diagram 800 illustrates an initial empty 5×5 symbol matrix 802-1 which includes columns 804, 806, 808, 810, and 812, symbol positions 814, and rows 816, 818, 820, 822, and 824. In a 5×5 matrix such as matrix 802-1, there may be twenty-five symbol (25) positions 814. At a process operation 826, trigger symbols 828 that landed in a 3×5 symbol matrix of the base game are carried over into the 5×5 feature game symbol matrix. As shown, seven trigger symbols 828 are present in matrix 802-2 after process operation 826, reflecting that seven trigger symbols landed in the base game symbol matrix. The operation of carrying over trigger symbols from the base game to the feature game may include storing a state of the landed trigger symbols in the base game in a memory so that the trigger symbols can be ported to corresponding positions in the feature game. Accurately storing and/or tracking of a state of the various placed trigger symbols represents an improvement in executing target game patterns in an RNG-driven gaming architecture. In some embodiments, placement selector 326D may be additionally configured to provide and/or assist with the tracking of placed symbols (as well as the tracking of placed tokens and multipliers).

Process operation 826 may also include determining a minimum number of game patterns related to population of the 5×5 matrix 802-2, although in some embodiments determining the minimum number of game patterns may be performed separately and/or in a different order of occurrence. Process operation 826 may be implemented based on an output from pattern selector 326A. The output from pattern selector 326A may be based in part on an output from rate regulator 326B, such as in connection with the control of landing rates of target game patterns as described herein. For example, the outputs from pattern selector 326A and/or rate regulator 326B may be implemented as part of the technical solution for a process for regulating random symbol generation so that randomness remains fair and unpredictable while maintaining consistency in landing rates of target game patterns within an RNG-driven gaming architecture. In the exemplary embodiment, the game pattern is a bingo line pattern used in conjunction with a given row and/or column. The minimum number of game patterns may determine win amounts in the feature game and may be set to a value stored in one or more lookup tables, such as an arbitrary number such as two, without limitation. Other embodiments may include more or less minimum number of game patterns than two. In some embodiments, a bingo line pattern may include not only row and column patterns, but also or alternatively diagonal line patterns, “4 corners”, “blackout”, and/or other bingo patterns. In some embodiments, a minimum number of game patterns is different for each player within a given session of play in scenarios where common/joint play is a feature of the game. In other embodiments, a same minimum number of game patterns is selected for each player partaking in a common/joint session of play, however a script for conveying the game outcome for each player may be executed on an individualized basis.

For example, matrix 802-2 after process operation 826 may reflect a determination of two minimum game patterns (e.g., two bingo lines), and that the current distribution of symbols 828 does not satisfy the minimum number of bingo lines. That is, the distribution of symbols 828 from the base game, and such as shown in matrix 802-2, do not form a bingo line. Process operation 830 includes randomly adding new/additional trigger symbols 832 to carried over symbols 828 until the minimum number of bingo lines is reached, which may be executed by an RNG pull and a lookup in a corresponding lookup table as described herein. For example, matrix 802-3 after process operation 830 illustrates that nine new trigger symbols 832 were added, forming three separate bingo lines (e.g., at column three and rows one and two). In general, symbols 828 are the same as or similar symbols 420 in FIG. 5A, and symbols 832 are the same as or similar to symbols 520 in FIGS. 5B-5E (e.g., the primary distinction between symbols 420/828 and 520/832 being that symbols 520/832 were placed after symbols 420/828).

In some embodiments, the minimum number of bingo lines may range from 0 to 10 (e.g., for a 5×5 symbol matrix). The minimum number of bingo lines may be set as desired, or randomly determined. For example, an output from pattern selector 326A may be implemented for determining the minimum number of bingo lines. In a case where the minimum number of bingos is randomly determined, the likelihood of any given minimum number of bingo lines may be based on a weighting. For example, it may be more likely for the minimum number of bingo lines to be two than to be seven. Similarly, it may be more likely for the minimum number of bingo lines to be two than 1, but by less of a margin than compared to the likelihood of the minimum number being two versus the minimum number being seven. However, weighting may also be implemented in other (e.g., non-random) pattern selections. In some embodiments, the distribution of minimum numbers ranging from 0 to 10 may approximate a bell curve distribution. The actual weights and likelihoods (e.g., odds) of bingos being awarded may be set based on a variety of considerations, including but not limited to compliance with any applicable rules/regulations and gameplay design factors. These weights/odds may be stored within special weighted tables described herein, such as in connection with FIG. 12A (described below).

FIG. 8B illustrates a diagram 834 showing a population process of jackpot tokens and multipliers according to one embodiment of the present disclosure, and such as shown in and described in connection with FIGS. 5A-5E, and in connection with outputs from token selector 326F and prize selector 326G of process control module 324. With reference to FIG. 8A, after matrix 802-3 has been populated with some or all of the trigger symbols (e.g., symbols 828 in addition to symbols 832) that it will receive, for example from a play of the feature game, the next operations may include determining and placing jackpot tokens and determining and placing multiplier prizes for the various rows and columns of the matrix associated with a bingo win.

Process operation 836 includes determines how many jackpot tokens (e.g., tokens 516 shown in FIG. 5A) will be awarded, such as by lookup in a corresponding lookup table. A maximum number of jackpot token available to be distributed may be a fixed quantity defined in the rules of the electronic game and/or for reference in a lookup table. In the exemplary embodiment, four jackpot tokens will be placed, but a number of winning tokens may be randomly determined such as via an RNG call. For example, while four tokens may be placed, only two of the tokens may be winning tokens. This is merely for example and other iterations of the number of winning tokens are envisioned. In this regard, the number of winning tokens of the four winning tokens may be weighted such that in general, it is more likely to land one winning token than four winning tokens. Moreover, the weight of the number of tokens to be placed may be based upon how many bingo line wins are awarded. For example, zero tokens may be awarded if a low amount of bingo line wins land, where the likelihood that zero tokens are awarded decreases with an increase in awarded bingo line wins. Similarly, the other distributions (e.g., one, two, three, four) of awarded tokens may be weighted in correspondence with the amount of bingo line wins. For example, four tokens may be awarded for a high amount of awarded bingo line wins (which, in the case of a 5×5 matrix, is a maximum of 10 bingo lines wins). Intervening awarded tokens (e.g., one, two, three awarded tokens) may be weighted in a manner than generally falls within the above-described examples relating to zero and four awarded tokens. However, the actual weights and likelihoods (e.g., odds) of tokens being awarded may be set based on a variety of considerations (e.g., not just the amount of bingo line wins), including compliance with any applicable rules/regulations. These weights/odds may be stored within special weighted tables described herein, such as in connection with FIG. 12B (described below).

Continuing the example shown and described in matrices 802-1 to 802-3 shown in and described in connection with FIG. 8A, matrix 802-4 in FIG. 8B illustrates placement of winning and losing tokens (e.g., tokens 516 such as shown in FIG. 5A). Matrix 802-4 shows that the minimum number of bingo line wins (e.g., two) has been satisfied, and that another bingo line win was awarded, for a total of three bingo line wins. Four jackpot tokens represented by the letter “T” in FIG. 8B have been placed on various corresponding rows and columns of matrix 802-4, including tokens 838, 840, 842, and 844. Of these four tokens, only token 838 may be a winning token, and the other three tokens (840, 842, 844) may be losing tokens. Other winning/losing token combinations may occur as described herein. The weighted values and/or relationships of the tokens may be stored in a weight table and/or other table (e.g., lookup table) for reference and in connection with RNG calls, as described in connection with FIG. 12B (described below), for example.

Continuing the example shown and described in matrices 802-1 to 802-3 shown in and described in connection with FIG. 8A and matrix 802-4, FIG. 8B further illustrates placement of randomly generated prizes, such as remaining prizes to fill the rows and/or columns that are not occupied by a token. The prizes may include, but are not limited to, multiplier prizes in a variety of multiplier levels (e.g., 2×, 3×, 5×, 7×, 10×, 20×, etc.). Process operation 846 may include performing an RNG call to randomly determine and/or place the prizes in association with a corresponding lookup table as described herein. In the example shown in FIG. 8B, six multiplier prizes are awarded, including prize 848 (e.g., 2×), prize 850 (e.g., 8×), prize 852 (e.g., 2×), prize 854 (e.g., 3×), prize 856 (e.g., 4×), and prize 858 (e.g., 3×) (where a designator of “×3” is the same as “3×” and vice versa, for all multiplier levels). Of prizes 848-858, only prizes 848 and 856 may be awarded, whereas prizes 850, 852, 854, and 858 may not be awarded. Multiplier prizes may have a set likelihood of being awarded. For example, in general, it may be more likely to be awarded a 2× multiplier than a 10× or 20× multiplier. However, the actual weights and likelihoods of prizes being awarded may be set based on a variety of considerations, including compliance with any applicable rules/regulations. The weighted values and/or relationships of the prizes may be stored in a weight table and/or other table (e.g., lookup table) for reference and in connection with RNG calls, such as described in connection with FIG. 12C (described below), for example.

FIG. 8C is a diagram 860 illustrating additional aspects of how a game outcome is determined. In this case, and as shown in FIG. 8C, matrix 862 may already have a plurality of landed trigger symbols 864, and the minimum number of winning game patterns (e.g., bingo lines) may be two. Symbol position 866 may be determined to be the next position to be filled with a trigger symbol 864. However, the landing of a trigger symbol 864 in symbol position would simultaneously create two winning bingo lines for a total of three winning bingo lines (e.g., since there was already one full bingo line), which would be one winning bingo line over the set minimum of two winning lines. In Option A (e.g., as indicated by the “A” arrow shown in FIG. 8C), which may reflect the exemplary embodiment, a symbol 864 is selected (e.g., via an RNG pull and corresponding lookup) to land in symbol position 866 and is permitted to remain in place via the result of back-end determinations, even though the landing of symbol 864 in position 866 results in three total winning bingo lines. In Option B (e.g., as indicated by the “B” arrow shown in FIG. 8C), when symbol 864 is selected to land in position 866, the back-end script may cause the selected symbol to not be applied to the position in the matrix (e.g., the symbol is scrapped on the back-end), as indicated by the “X” 868, because a symbol in position 866 would cause three winning bingo lines (e.g., which exceeds the predetermined minimum bingo wins by one winning line). Once the symbol that was set to land in position 866 is scrapped, a new symbol position may be selected for filling with a symbol. Accordingly, either of Option A or Option B may be implemented depending on how permissive or player-friendly the game is desired to be, and/or based on other odds, weights, regulations, etc. Options A and B may be determined in association with outputs from pattern selector 326A, rate regulator 326B, and/or placement selector 326D, for example, although other outputs from process control module 324 may also be relied upon.

Additionally, in the exemplary embodiment, a game engine may include a single RNG. One RNG call and output thereof may be utilized for each of determining (i) the minimum number of winning bingo lines, (ii) where each trigger symbol will land (including any re-land decisioning as discussed in connection with “X” 868), (iii) where each token will be placed, and/or (iv) where each multiplier will be placed. Put another way, the same RNG is used for each of items (i) through (iv) listed in this paragraph, but different RNG outputs are used for each of item (i) through (iv). Alternative implementations may utilize one or more RNG outputs differently. Moreover, this list of items (i) through (iv) is not limiting and an RNG pull from one or more RNGs may be implemented for other decisioning, and/or multiple RNG pulls may be utilized for determine any given gameplay aspects (e.g., awarded bingos, awarded tokens, and/or awarded multipliers).

Referring back to FIG. 3, the various RNG calls and lookups in corresponding lookup tables may be implemented via RNG engine 316, RNG conversion engine 320, lookup tables 322A to 322N, and process control module 324. For example, tables 322A to 322N may have dedicated tables for each of (i) the minimum number of winning bingo lines, (ii) where each trigger symbol will land (including any re-land decisioning as discussed in connection with “X” 868), (iii) where each token will be placed, and/or (iv) where each multiplier will be placed, where entries in the various tables may be weighted as described herein. The various control elements 326A to 326H may be executed as part of processing the results of the various RNG calls for controlling the outcome of the feature game. For example, control elements such as pattern selector 326A, symbol selector 326E, token selector 326F, and/or prize selector 326G may be configured to perform cross-referencing of the results of the RNG calls to lookup tables 322A to 322N, including dedicated lookup tables such as shown and described in connection with FIGS. 12A-12C.

FIG. 9A is a block diagram 900 illustrating aspects of a feature script process of the feature game according to one embodiment of the present disclosure. More specifically, the feature script may relate to providing improved randomness and be used in connection with managing so-called “dead spins” of the feature game. A “dead spin” may be one or more spins where a bingo line win does not result in the feature game. Block 902 includes making an initial determination as to whether there is a “dead spin”. Block 904 is a branch illustrating a “NO” determination, where a “dead spin” is determined to not be shown. Block 906 is a branch illustrating a “YES” determination to show a “dead spin.” From block 906, there is another determination to be made at block 908 if is there have already been a certain amount of “dead spins” in a row (e.g., such as three “dead spins” in a row). From block 908 there are two possible determinations. Block 910 is a branch illustrating a “YES” determination in response to block 908. From either of block 904 or block 910, the next block is block 912, illustrating a determination to add n symbols in the spin (e.g., a next spin). Block 914 is a branch illustrating a “NO” determination stemming from block 908. From block 914, the next block is block 916, illustrating a determination to add no (e.g., zero) symbols to the spin (e.g., a next spin). This implementation of a dead spin tracking tool as part of a feature script is a technical improvement in tracking a state of dead spins, and also increases player engagement and moves the game along while improving the distribution of bingo line wins. That is, after generating the game outcome, the game processing pipeline generates the feature script on how the feature will be presented to a player and introduces more randomness when presenting the game outcome to the player. This use of a feature script also aids in improving security as described herein, by reducing the likelihood of potential reverse engineering techniques (e.g., since back-end determinations may be made to impact what is actually displayed to a player).

FIG. 9B is a block diagram 918 illustrating aspects of a feature script process of the feature game according to one embodiment of the present disclosure. The outcome of the hold and spin feature may be scripted according to a series of sequential operations, although the order shown in FIG. 9B is not limiting and represents one example implementation of execution of the outcome. Operation 920 includes determining a minimum number of bingo wins. This determination may be made in association with one or more weighted tables as described herein. Operation 922 includes placing initial trigger symbols such as the diamond symbols described and shown herein. This placement may be determined randomly or along another (e.g., pre-determined) basis. Operation 924 includes adding additional trigger symbols until the determined number of minimum bingo wins is reached. These additions may be determined randomly. Operation 926 includes determining tokens, including which tokens will be winning tokens and which tokens will be non-winning tokens. This determination may be made in association with one or more weighted tables as described herein. Operation 928 includes placing the various determined tokens in association with the symbol matrix as shown and described herein. This placement may be determined randomly or along another (e.g., pre-determined) basis. Operation 930 includes determining/generating other prizes, such as multiplier prizes as described herein. This determination may be made in association with one or more weighted tables as described herein. Operation 932 includes generating the feature script that will convey the results of the determined outcome. Operation 934 includes visually displaying the game outcome, based on the script, on a screen of a gaming device. Operation 936 includes accounting for dead spins, as shown and described herein, such as via FIG. 9A.

Further regarding operation 922 of placing initial trigger symbols, in some embodiments, initial trigger symbols may be deliberately placed in an intentionally spaced-out configuration. That is, the placement of initial symbols is not overly important, at least because the additional subsequent symbols may be controlled such as with respect to the number of winning bingos and the like. Moreover, the look and feel of absolute randomness can be achieved but within the constraints of the number of bingo wins.

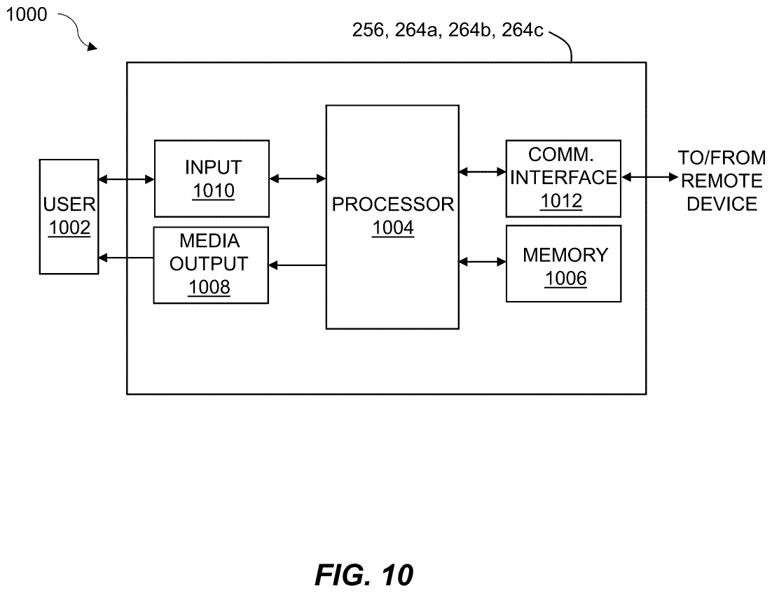

FIG. 10 illustrates an example configuration 1000 of personal computing devices such as mobile devices 256 and/or EUDs 264a, 264b and 264c that a user (e.g., player) 1002 may use to play the electronic game, where user 1002 may be the same as or similar to users 274a-274c. Each mobile device 256 and/or EUD 264a, 264b, and 264c includes a processor 1004 operatively coupled with a memory 1006. Each mobile device 256 and/or EUD 264a, 264b and 264c also includes at least one media output component 1008 for presenting information (e.g., the electronic game) to user 1002. In some embodiments, media output component 1008 includes an output adapter such as a video adapter and/or an audio adapter. An output adapter is operatively coupled to processor 1004 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, each mobile device 256 and/or EUD 264a, 264b and 264c includes an input device 1010 for receiving input from user 1002. Input device 1010 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1008 and input device 1010. Each mobile device 256 and/or EUD 264a, 264b and 264c further includes a communication interface 1012 so that each mobile device 256 and/or EUD 264a, 264b and 264c may communicate with other computing devices (e.g., remote devices) within the system(s) shown and/or referenced in FIGS. 1, 2A, 2B, 2C, 3.

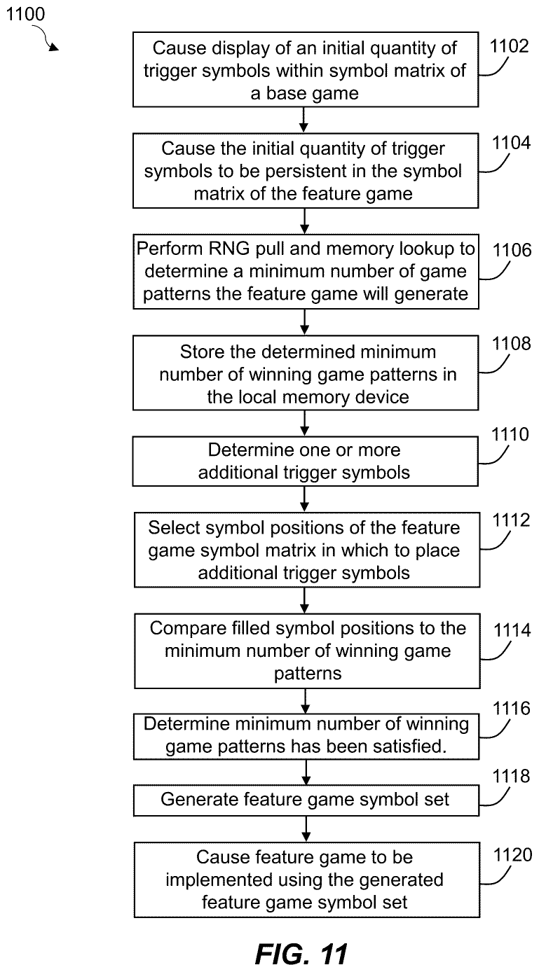

FIG. 11 illustrates an example method 1100 for providing the electronic game shown, for example, in FIGS. 4A, 4B, 5A-5G, 6, 7A-7C and/or 13A-13J. Method 1100 includes causing 1102 display of an initial quantity of trigger symbols each within a symbol position of a symbol matrix of a base game of an electronic game, the initial quantity of trigger symbols triggering a feature game, such as shown in FIG. 4B. Method 1100 also includes causing 1104 the initial quantity of trigger symbols to be persistent by continuing to be displayed in same symbol positions in the symbol matrix of the feature game as in the base game symbol matrix. Method 1100 also includes performing 1106 a random number generator (RNG) pull and associated memory lookup to determine a minimum number of winning game patterns the feature game will generate. The at least one memory may include a local memory device for improving the speed with which the comparison can be performed (e.g., faster memory read times). Method 1100 also includes storing 1108 the determined minimum number of winning game patterns in the local memory device. Method 1100 also includes (randomly) determining 1110, for display within the symbol positions of the feature game symbol matrix, one or more additional trigger symbols. Method 1100 also includes (randomly) selecting 1112, as part of a symbol filling processing stage, symbol positions of the feature game symbol matrix in which to place respective trigger symbols of the one or more additional trigger symbols, based, for example, on a determination of if the symbol positions are already occupied by a trigger symbol. Method 1100 also includes after each filling of an unoccupied symbol position in the symbol filling processing stage, comparing 1114 each filled symbol position of the feature game symbol matrix to the minimum number of winning game patterns stored in the local memory. Method 1100 also includes determining 1116 that the minimum number of winning game patterns has been satisfied. Method 1100 also includes generating 1118 a symbol set for the feature game, the symbol set including the initial quantity of trigger symbols and each trigger symbol resulting from the symbol filling processing stage. Method 1100 also includes causing 1120 the feature game to be implemented using the generated feature game symbol set.

In some embodiments, the electronic game shown in FIGS. 4A, 4B, 5A-5G, 6, 7A-7C and/or 13A-13J may be displayed by gaming devices 104A-104X in addition to or alternatively to other gaming devices such as mobile gaming devices.

In some embodiments, one or more of the threshold amounts of trigger symbols, bingo line wins, awarded tokens, and awarded prizes may have a different probability of being awarded. For example, a 2× multiplier may have a higher probability of landing than all four jackpot tokens. To achieve this, each RNG call to determine if the corresponding features/prizes may be evaluated using a different pay table or series of lookup values associated with such features/prizes.

In some embodiments, the game outcome may include a set of reels including a plurality of symbols, for example, displayed in respective matrix positions of the reels. The game outcome may be determined randomly, for example, by performing a lookup using one or more pay tables based on one or more RNG outcomes.

FIGS. 12A-12C illustrate example specialized lookup tables for various aspects of the electronic game. FIG. 12A illustrates a lookup table in the form of weighted table 1200 corresponding to a number of minimum bingos to be awarded for a play of the electronic game. As shown in FIG. 12A, column 1202 of table 1200 lists the number of minimum bingos ranging from 0 to N, and column 1204 of table 1200 lists corresponding weights/odds for each number of bingos. For example, an award of 0 bingos has weight/odds W₁, an award of 1 bingo has weight/odds W₂, and so on and so forth through N bingos that has weight/odds W_{N}. In some embodiments, N may be 10 (e.g., 10 minimum bingos, corresponding, for example, to a “blackout” state where each row/column/diagonal of a 5×5 matrix results in a bingo). In general, the odds may be set to decrease as the number of bingos increase. For example, W₈ associated with 7 bingos being awarded may reflect a lesser likelihood as compared to W₄ associated with 3 bingos being awarded. An RNG pull may be made and the result thereof mapped to a position in table 1200 corresponding to the various potential bingos, for determining the minimum number of bingos to be awarded. Table 1200 may be implemented and stored as part of game processing backend system 314 shown in FIG. 3, and more specifically as part of RNG conversion engine 320. For example, table 1200 may be one implemented as any one or more of lookup tables 322A to 322N. However, this is not limiting, and table 1200 may be implemented and/or stored within other memory areas such as shown and described in FIGS. 2A to 2C, for example. By using special weighted tables such as table 1200, improved control over the degree of randomness in a random gaming environment is realized.

FIG. 12B illustrates a lookup table in the form of weighted table 1206 corresponding to a number of tokens (e.g., see element 1316 in FIG. 13A, described below) to be awarded for a play of the electronic game. As shown in FIG. 12B, column 1208 of table 1206 lists the number of tokens ranging from 0 to 4, and columns 1210 to 1216 of table 1206 list weights/odds for the token award levels relative to the number of awarded bingos, where the awarded bingos may range from 0 bingos to Z+N bingos awarded. Columns 1210-1216 represent four ranges of bingos that have been awarded and represent one example of how the total amounts of awarded bingos may be split into ranges. For example, where Z+N equals 10 bingos (such as in embodiments including a 5×5 matrix), the total range reflected in columns 1210-1216 spans from 0 bingos to 10 bingos, where the intermediate columns 1212 and 1214 represent sub-ranges within the overall 0 -10 bingos range. For example, column 1212 may represent a case where 5-6 bingos were awarded.

Further regarding the weights/odds listed in table 1206, and using column 1210 as an example, weight/odds W₁ through W₅ may be set such that it is generally less likely to have 4 tokens awarded when 0 to X bingos have been awarded than it is 0 tokens to be awarded when 0 to X bingos have been awarded. For example, column 1210 may correlate to an early stage of a session of play of the electronic game, and it may be desired to reduce the likelihood that a maximum number of tokens (e.g., 4 tokens) would be awarded at such an early stage of play, and as such W₁ through W₅ may be set to reflect such desired aspects for play of the game. However, the odds within any given column may be set in a manner that satisfies any number of design parameters of the game (while maintaining compliance with RTP, regulations, and the like). For example, column 1214 represents a majority of possible bingos having been awarded (e.g., a number of bingos close to the maximum number of possible bingos able to be awarded). Based on design parameters of the game, weights/odds may be set such that it is very unlikely that only 0 or 1 tokens will be awarded if the majority of possible bingo awards have been achieved, meaning that in general, weights/odds W₁₁ and W₁₂ may be less than each of weights/odds W₁₃ through W₁₅. An RNG pull may be made and the result thereof mapped to a position in table 1206 corresponding to the various potential tokens, for determining the number of tokens to be awarded. Table 1206 may be implemented and stored as part of game processing backend system 314 shown in FIG. 3, and more specifically as part of RNG conversion engine 320. For example, table 1206 may be one implemented as any one or more of lookup tables 322A to 322N. However, this is not limiting, and table 1206 may be implemented and/or stored within other memory areas such as shown and described in FIGS. 2A to 2C, for example. By using special weighted tables such as table 1206, improved control over the degree of randomness in a random gaming environment is realized.

FIG. 12C illustrates a lookup table in the form of weighted table 1218 corresponding to other prizes such a multiplier prizes (e.g., see element 1318 in FIG. 13A, described below). As shown in FIG. 12C, column 1220 of table 1218 lists various types of multipliers capable of being awarded (e.g., 2×, 3× . . . Nx), and column 1222 lists the corresponding weights/odds (W₁ through W_{N}) for each multiplier type. In general, weights/odds (W₁ through W_{N}) may be set such that the likelihood of a 20× multiplier being awarded is less than the likelihood of a 2× multiplier being awarded. For example, multipliers may be placed in association with any column/row that does not have an associated token.

FIGS. 12A-12C illustrate one example of three different types of special weighted tables and are not limiting. For example, more or less special weighted tables may be implemented to arrive at a desired level of control of elements (e.g., randomness) of the game. As one example of how the special weighted tables shown in FIGS. 12A-12C may be modified and/or otherwise defined differently, table 1206 in FIG. 12B shows four different ranges of awarded bingos. Rather than have one table (e.g., 1206) listing all four ranges, each range could instead have its own special weighted table. Additionally, the various special weighted tables may have certain interplay therebetween to control award levels within the game. For example, if an outcome of the game is that a majority of the prizes will be awarded early on (e.g., in the first 3 spins of 10 total free spins), different special weighted tables may be utilized to better control randomness and/or the distribution of awards, such as tracking and/or avoiding “dead spins” as described herein. As another example, if maximum (e.g., 4) tokens have been awarded, a different weighted table for remaining prizes such as multiplier prizes may be used, where the weights/odds of landing large multipliers (e.g., 20×) may reflect revised weights/odds set in view of the maximum token level. Accordingly, special weight tables such as tables 1200, 1206, and 1218 represent improvements in control of the randomness of game aspects while also providing flexibility, representing technical improvements to electronic games and/or the field of electronic gaming.

By using special weighted tables such as table 1218, improved control over the degree of randomness in a random gaming environment is realized. That is, at least the special weighted tables described herein improve the control of randomness when generating game outcomes that trigger additional awards in a Hold and spin feature. Additional benefits of the special weighted tables described herein include but are not limited to improved tuning and/or dynamic adjustment (e.g., RTP tuning, RTP dynamic adjustment), and improved game design flexibility, including improved flexibility for implementing complex features. Moreover, data associated with the special weighted tables may provide mass amounts of data points that can be analyzed to improve game performance. Improvements to these various aspects represent technical improvements to electronic games and/or the field of electronic gaming and solutions to technical challenges such as limited flexibility, limited randomness, and the like.

The role of process control module 324 shown in FIG. 3 in the various process control operations and/or aspects thereof described herein is explained in additional detail below. With reference to FIGS. 8A and 12A, additional trigger symbols such as symbols 832 are populated in symbol positions 814, where the population of trigger symbols 832 in symbol positions 814 may be executed by symbol selector 326E, placement selector 326D, rate regulator 326B, and/or pattern selector 326A, such as part of process operation 830. For example, in connection with one or more RNG pulls, one or more initial additional trigger symbols 832 may be determined by symbol selector 326E and distributed in accordance with symbol distribution parameters programmed in association with placement selector 326D. Symbols 832 may be populated in accordance with a corresponding RNG pull(s) and in association with table 1200 shown in FIG. 12A with respect to determining the number of winning bingos in association with pattern selector 326A. For example, pattern selector 326A may be programmed with pattern determination parameters and rate regulator 326B may be programmed with rate regulation parameters, so that the amount and/or frequency of bingo patterns can be resolved.

With reference to FIGS. 8B and 12B, tokens such as tokens 838 to 844 are populated in association with rows and/or columns of the symbol matrix (e.g., symbol matrix 802-4), where the population of tokens 838 to 844 may be executed by token selector 326F and placement selector 326D as part of process operation 836. For example, in connection with one or more RNG pulls, one or more tokens such as tokens 838 to 844 may be determined by token selector 326F and distributed in accordance with token distribution parameters programmed in association with placement selector 326D. Token selector 326F may, in association with the RNG pull (s) and table 1206 shown in FIG. 12B, determine the amount of winning tokens such as token 838 and/or the amount of non-winning tokens such as tokens 840 to 844.

Further referencing FIG. 8B and also referencing FIG. 12C, prizes such as multiplier prizes 848 to 858 are populated in association with rows and/or columns of the symbol matrix (e.g., symbol matrix 802-5), where the population of prizes 838 to 844 may be executed by prize selector 326G and placement selector 326D as part of process operation 846. For example, in connection with one or more RNG pulls, one or more prizes such as prizes 848 to 858 may be determined by prize selector 326G and distributed in accordance with prize distribution parameters programmed in association with placement selector 326D. Prize selector 326G may, in association with the RNG pull(s) and table 1218 shown in FIG. 12C, determine the number and type (e.g., 2×, 5×, etc.) of prizes such as prizes 848 to 858.

With reference to FIG. 8C, pattern selector 326A, rate regulator 326B, and placement selector 326D may be further programmed to function in accordance with parameters such as weights/odds shown in column 1204 in FIG. 12A to determine, in association with one or more RNG pulls, an amount of winning game patterns for a given instance of the game. For example, pattern selector 326A alone or in combination with outputs from rate regulator 326B may make determinations such as those associated with the filling of position 866 and Options A and B shown in and described in connection with FIG. 8C. If Option A is selected, trigger symbol 864 may be placed in accordance with an output from placement selector 326D. If Option B is selected, the symbol removal process associated with “X” 868 may be executed in accordance with an output of placement selector 326D.

With reference to FIG. 9A, dead spin counter 326C and/or rate regulator 326B may be programmed with dead spin parameters and/or rate parameters, respectively, that are configured to count and provide rate decisioning relative to the count. For example, as shown in FIG. 9A, upon a determination such as at block 908 regarding whether a threshold number of dead spins have occurred and been counted by dead spin counter 326C, rate regulator 326B may may be programmed to cause n symbols to be added as shown in connection with block 912, where such additional n symbols may be placed by placement selector 326D.

With reference to FIG. 9B, the various control elements 326A-326H of process control module 324 may function and operate as follows. Operation 920 may be executed in whole or in part by pattern selector 326A. Operation 922 and 924 may be executed in whole or in part by placement selector 326D, including outputs from rate regulator 326B and/or symbol selector 326E. Operation 926 may be executed in whole or in part by token selector 326F, including outputs from placement selector 326D. Operation 930 may be executed in whole or in part by prize selector 326G, including outputs from placement selector 326D. Operation 932 may be executed in whole or in part by script generator 326H. Operation 366 may be executed in whole or in part by dead spin counter 326C, including outputs from symbol selector 326E and placement selector 326D.

With reference to FIG. 11, the various control elements 326A-326H of process control module 324 may function and operate as follows. Operations 1106 and 1108 may be executed in whole or in part by pattern selector 326A. Operation 1110 may be executed in whole or in part by placement selector 326D, including outputs from rate regulator 326B and/or symbol selector 326E. Operation 1112 may be executed in whole or in part by placement selector 326D. Operations 1114 and 1116 may be executed in whole or in part by pattern selector 326A. Operation 1118 may be executed in whole or in part by script generator 326H.

Additionally, in some embodiments, performing the symbol filling processing stage described herein is executed without mapping an RNG call to a reel strip stop position when filling each unoccupied symbol position of the feature game symbol matrix. For example, using independent reels to determine trigger symbol landings may be avoided to avoid generating game outcomes with no bingo line wins that hit at a fast rate. In other words, this avoidance may be implemented to counteract the effect of bingo lines not triggering due to independent reel randomness. In one aspect, this includes not mapping RNG calls to reel strip stop positions for determining where trigger symbols land, and instead using symbol filling aspects such as shown in FIGS. 8A-8C. Accordingly, while reel strips may be used in the base game for symbol selection, no reel strips may be used in the feature game for symbol selection. This is a technical improvement that allows for further control of randomness and improved control of game flow and/or game presentation. Additionally, by not using reel strips in the feature game, a reduction in the likelihood of potential reverse engineering of the game may be realized (e.g., the security of the game is increased making the game more robust against reverse engineering tactics such as determining symbol distributions on a given reel strip). For example, on the back-end no reel strips are used for symbol determination in the feature game, but on the front-end, a fake/façade reel strip can spin in connection with populating the symbols. This shields the underlying symbol determination process, while still giving the appearance of the random of reel spins.

Accordingly, by way of at least the special weighted tables and particularized symbol selection process(es) in the feature game described herein, improvements in the randomness and/or derivation of game outcomes are improved, representing solutions/improvements to the technical challenges described herein.

FIGS. 13A to 13J illustrate aspects similar to what is shown in FIGS. 5A to 5M, including interfaces of a hold and spin feature game such as a hold and spin bingo feature game that may be provided and displayed on mobile gaming devices 256 and/or EUDs 264a, 264b and 264c, as described herein. As shown in FIG. 13A, interface 1300A of the hold and spin feature game may include a symbol matrix 1302 including a reel set that includes a plurality of reels 1304-1312, and symbol positions 1314 corresponding to symbol matrix 1302 and the various rows/columns. For example, in the case of a 5×5 symbol matrix shown in FIG. 13A, there are 25 symbol positions 1314. FIG. 13A also shows jackpot tokens 1316 positioned in association with certain rows/columns of symbol matrix 1302, and multiplier prizes 1318 positioned in association with certain other rows/columns of symbol matrix 1302. FIGS. 8A, 8B and/or 12B and 12C and their corresponding descriptions show and describe additional aspects relating to these placement techniques, including as executed by process control module 324 and/or as described herein in connection with FIGS. 5A to 5E. FIG. 13A also shows trigger symbols 1320 that have been placed in correspondence with the populating of awarded bingos such as described and shown in connection with process control module 324 and FIGS. 8A and 12A and corresponding credit values 1322 of the symbols. Various jackpots are shown via corresponding jackpot graphics 1324-1330, where jackpot graphic 1324 indicates a MINI jackpot, jackpot graphic 1326 indicates a MINOR jackpot, jackpot graphic 1328 indicates a MAJOR jackpot, and jackpot graphic 1330 indicates a GRAND jackpot. Each of jackpot graphics 1324-1330 included a token landing spot graphic 1332 indicating a spot to be filled with awarded tokens 1316. In the embodiment shown in FIG. 13A, jackpot graphic 1324 includes one token landing spot graphic 1332, jackpot graphic 1326 includes two token landing spot graphics 1332, jackpot graphic 1328 includes three token landing spot graphics 1332, and jackpot graphic 1330 includes four token landing spot graphics 1332. FIG. 13A also shows a remaining spins graphic 1334 indicating a number of spins available/remaining for the hold and spin feature, which provides a visual indication of the respin aspects of a hold and spin feature as described in connection with FIG. 3 (see also spin indicator 534 in FIG. 5B). The number of spins may fluctuate over the course of the play of the hold and spin as spins are decremented and/or added if additional free spins are awarded (e.g., in embodiments where additional free spins are capable of being won during the course of the hold and spin). FIG. 13A shows that while various trigger symbols 1320 have been placed, no bingos have been achieved.

FIG. 13B shows interface 1300B and the addition of two more trigger symbols 1320 (e.g., at symbol positions corresponding to the first column/third row and rightmost column/bottom row), as executed by process control module 324 as described herein. Credit values 1336 of the newly placed trigger symbols 1320 are shown, where credit values 1336, consistent with credit values 1322 of the already landed existing symbols 1320. FIG. 13B also represents a state where a bingo has been achieved at the rightmost column.

FIG. 13C shows interface 1300C and the display of bingo graphics 1338 in the column where a bingo was achieved, providing visual indication of the awarded bingo. As shown, there is a token 1316 corresponding to the column where the bingo was achieved.

FIG. 13D shows interface 1300D and the display of a token distribution animation 1340 indicating distribution of the collected token 1316 in a direction toward the jackpot graphics area including jackpot graphics 1324-1330 and their corresponding empty token landing spot graphics 1332. As shown in FIG. 13D, token 1316 that was previously located above the rightmost column is no longer present, providing visual indication that that token has been collected. Four tokens 1316 are shown as part of animation 1340, indicating one token to be distributed to each of the four jackpots (e.g., to fill the first landing spot 1332 for each jackpot). Animation 1340 may be executed in accordance with an output of token selector 326F and/or placement selector 326D with respect to selection and placement of the tokens. For example, placement selector 326D may also be implemented to control placement of awarded tokens 1316 in landing spots indicated by landing spot graphics 1332.

FIG. 13E shows interface 1300E and the awarded token(s) 1316 seated in corresponding landing spots 1332 of the various jackpot graphics. As shown, the first landing spot 1332 of each jackpot graphic 1324-1330 is now filled (where jackpot graphic 1324 includes only one landing spot 1332).

FIG. 13F shows interface 1300F and that an additional trigger symbol has been placed in the symbol position corresponding to the middle column/bottom row relative to the placed symbols shown in FIG. 13E. However, no new bingo has been awarded.

FIG. 13G shows interface 1300G and that an additional trigger symbol has been placed in the symbol position corresponding to the fourth column/second row relative to the placed symbols shown in FIG. 13F. The additional symbol placed in FIG. 13G results in a bingo for the second row.

FIG. 13H shows interface 1300H and the display of bingo graphics 1338 in the row where a bingo was achieved, providing visual indication of the awarded bingo. As shown, there is a multiplier prize 1318 (e.g., 2×) corresponding to the row where the bingo was achieved.

FIG. 13I shows interface 1300I including multiplier graphics 1342 that visually display the awarded multiplied, which in the case of the example shown in FIG. 13I is 2×. Graphics 1342 provide visual indication of the distribution of the multiplier value to credit values 1322 of symbols 1320 within the winning bingo row. Multipliers may be determined based on outputs from prize selector 326G and placed in accordance with outputs from placement selector 326D shown and described in FIG. 3.

FIG. 13J shows interface 1300J and that the prior credit values 1322 of the symbols in the winning bingo row have been increased according to the applied multiplier value (e.g., by 2×). For example, a credit value of 2.00 shown in FIG. 13I is now 4.00 in FIG. 13J, and so on and so forth for the other credit values of the symbols in the winning bingo row, as shown by multiplied credit value(s) 1344.

The interfaces (e.g., 1300A to 1300J) shown in FIGS. 13A to 13J may be viewed individually and/or as part of a sequence, where taken together, interfaces 1300A to 1300J show examples of the awarding of a bingo that results in a collected token (e.g., see FIGS. 13B to 13D) and the awarding of a bingo that results in an awarded multiplier prize (e.g., see FIGS. 13G to 13J), including intermediate interfaces (and any corresponding animations, transitions, etc.) therebetween.

The outcome of a session of play of the game may be resolved in one or more stages/operations, such as shown and described in the example of FIG. 9B. Process control module 324 and its various control elements 326A-326H may generate outputs for each stage/operation as described herein. For example, once a feature such as a hold and spin has been triggered, various ordered steps may occur for determining the outcome of the hold and spin. In one embodiment, this includes a first operation of determining the minimum number of bingos to be awarded, such as by using table 1200. A second operation may include placing the (e.g., initial) trigger symbols (e.g., diamonds) for triggering a bingo. A third operation may include randomly adding trigger symbols to the total trigger symbols until the minimum number of bingos determined in the first operation is reached (e.g., the symbols placed in the second operation land to visually depict a bingo in a given row/column/diagonal). A fourth operation may include determining how many jackpot tokens will be awarded, such as by using table 1206. This may include both winning tokens and non-winning tokens. For example, one or more tokens such as token 1316 as shown in FIG. 13A may be associated with a given column or row, not all of these tokens will necessarily be awarded as shown in FIGS. 13C to 13E. A fifth operation may include placing non-winning tokens on the symbol matrix. In some embodiments, such as for 5×5 matrices, there may be a fixed number of non-winning tokens that are always placed (e.g., 4 non-winning tokens). A sixth operation may include randomly generating additional/remaining prizes such as the multiplier prizes 1318 shown in FIGS. 13H to 13J. A seventh operation may include generating a feature script for execution that plays out the results of the first through sixth operations for display to a player. In this regard, as shown in FIG. 9A, if it is known from the first operation that 3 bingos will be awarded, but there have already been a designated number of dead spins in the hold and spin, trigger symbols (e.g., diamonds) may be released to populate the symbol positions within the matrix so as to fill the requisite number of symbol positions to arrive at the pre-determined number of bingos. This aspect of tracking a state of dead spins and taking technical measures to curtail additional consecutive dead spins is a technical solution to the problem of dead spins in electronic slot-type games, solved by the technical solution represented in FIG. 9A.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for electronic gaming comprising:
at least one memory device storing instructions; and
at least one processor in communication with the at least one memory device, wherein the instructions, when executed by the at least one processor, cause the system to:
perform a random number generator (RNG) pull and associated memory lookup in a first lookup table stored in the at least one memory device to determine a minimum number of winning game patterns that a feature game will generate, the feature game being associated with a base game;
store the determined minimum number of winning game patterns in the at least one memory device;
determine, for display within symbol positions of a feature game symbol matrix, one or more initial trigger symbols and one or more additional trigger symbols;
select, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols;
after each filling of an unoccupied symbol position in the symbol filling processing stage, compare filled symbol positions of the feature game symbol matrix to the minimum number of winning game patterns stored in the at least one memory device;
determine that the minimum number of winning game patterns has been satisfied;
generate a symbol set for the feature game, the symbol set including the one or more initial trigger symbols and the one or more additional trigger symbols resulting from the symbol filling processing stage; and
cause the feature game to be implemented using the generated feature game symbol set.

2. The system of claim 1, wherein at least one trigger symbol of (i) the one or more initial trigger symbols and (ii) the one or more additional trigger symbols includes an associated modifiable credit value, and the instructions, when executed by the at least one processor, further cause the system to:
perform a random number generator (RNG) pull and associated memory lookup in another lookup table stored in the at least one memory device to determine a multiplier value associated with one or more modifiable credit values associated with the symbol set.

3. The system of claim 1, wherein a base game symbol matrix is a 3×5 matrix, wherein the feature game symbol matrix is a 5×5 matrix, wherein a winning game pattern type associated with the minimum number of winning game patterns is a bingo line pattern, and wherein the instructions, when executed by the at least one processor, further cause the system to expand the 3×5 base game symbol matrix to the 5×5 feature game symbol matrix upon initiation of the feature game.

4. The system of claim 1, wherein the instructions, when executed by the at least one processor, further cause the system to perform the symbol filling processing stage without mapping an RNG call to a reel strip stop position when filling each unoccupied symbol position of the feature game symbol matrix.

5. The system of claim 4, wherein the instructions, when executed by the at least one processor, further cause the system to display each unoccupied symbol position as a blank symbol position devoid of any symbol.

6. The system of claim 1, wherein the instructions, when executed by the at least one processor, further cause the system to:
perform a random number generator (RNG) pull and associated memory lookup in another lookup table stored in the at least one memory device to determine a winnable token associated with a respective row or column of one or more rows or columns of the feature game symbol matrix, wherein the winnable token is associated with one or more jackpot prizes associated with the feature game.

7. The system of claim 1, wherein the instructions, when executed by the at least one processor, further the system to randomly determine and cause display of one or more multiplier prizes associated with one or more rows or columns of the feature game symbol matrix based on a result of a lookup in a multiplier lookup table.

8. The system of claim 1, wherein the instructions, when executed by the at least one processor, further cause the system to generate a feature script for presentation of the generated feature game symbol set to a player of the feature game.

9. The system of claim 8, wherein the feature script includes presenting a visual orchestration of the generated feature game symbol set.

10. The system of claim 9, wherein the minimum number of winning game patterns is two.

11. A computer-implemented method for electronic gaming implemented using at least one memory device having instructions stored thereon and at least one processor in communication with the at least one memory device, the computer-implemented method comprising:
performing a random number generator (RNG) pull and associated memory lookup in a first lookup table stored in the at least one memory device to determine a minimum number of winning game patterns that a feature game will generate, the feature game being associated with a base game;
storing the determined minimum number of winning game patterns in the at least one memory device;
determining, for display within symbol positions of a feature game symbol matrix, one or more initial trigger symbols and one or more additional trigger symbols;
selecting, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols;
after each filling of an unoccupied symbol position in the symbol filling processing stage, comparing filled symbol positions of the feature game symbol matrix to the minimum number of winning game patterns stored in the at least one memory device;
determining that the minimum number of winning game patterns has been satisfied;
generating a symbol set for the feature game, the symbol set including the one or more initial trigger symbols and the one or more additional trigger symbols resulting from the symbol filling processing stage; and
causing the feature game to be implemented using the generated feature game symbol set.

12. The method of claim 11, further comprising performing the symbol filling processing stage without mapping an RNG call to a reel strip stop position when filling each unoccupied symbol position of the feature game symbol matrix.

13. The method of claim 12, further comprising displaying each unoccupied symbol position as a blank symbol position devoid of any symbol.

14. The method of claim 11, further comprising determining and causing display of (i) one or more jackpot tokens associated with one or more rows or columns of the feature game symbol matrix, wherein the one or more jackpot tokens are associated with one or more jackpot prizes associated with the feature game and (ii) one or more multiplier prizes associated with one or more rows or columns of the feature game symbol matrix.

15. The method of claim 11, further comprising generating a feature script for presentation of the generated feature game symbol set to a player of the feature game.

16. One or more non-transitory computer-readable storage media containing instructions thereon for controlling one or more electronic gaming devices, which when executed by one or more processors of the one or more electronic gaming devices, cause the one or more processors to:
perform a random number generator (RNG) pull and associated memory lookup in a first lookup table stored in the one or more non-transitory computer-readable storage media to determine a minimum number of winning game patterns that a feature game will generate, the feature game being associated with a base game;
store the determined minimum number of winning game patterns in the one or more non-transitory computer-readable storage media;
determine, for display within symbol positions of a feature game symbol matrix, one or more initial trigger symbols and one or more additional trigger symbols;
select, as part of a symbol filling processing stage, symbol positions of the feature game symbol matrix in which to place respective trigger symbols of the one or more additional trigger symbols, based on a determination of whether a respective symbol position of the symbol positions is already occupied by a trigger symbol of the one or more initial trigger symbols;
after each filling of an unoccupied symbol position in the symbol filling processing stage, compare filled symbol positions of the feature game symbol matrix to the minimum number of winning game patterns stored in the one or more non-transitory computer-readable storage media;
determine that the minimum number of winning game patterns has been satisfied;
generate a symbol set for the feature game, the symbol set including the one or more initial trigger symbols and the one or more additional trigger symbols resulting from the symbol filling processing stage; and
cause the feature game to be implemented using the generated feature game symbol set.

17. The one or more non-transitory computer-readable storage media of claim 16, wherein the instructions further cause the one or more processors to perform the symbol filling processing stage without mapping an RNG call to a reel strip stop position when filling each unoccupied symbol position of the feature game symbol matrix.

18. The one or more non-transitory computer-readable storage media of claim 17, wherein the instructions further cause the one or more processors to display each unoccupied symbol position as a blank symbol position devoid of any symbol.

19. The one or more non-transitory computer-readable storage media of claim 16, wherein the instructions further cause the one or more processors to randomly determine and cause display of (i) one or more jackpot tokens associated with one or more rows or columns of the feature game symbol matrix, and wherein the one or more jackpot tokens are associated with one or more jackpot prizes associated with the feature game and (ii) one or more multiplier prizes associated with one or more rows or columns of the feature game symbol matrix.

20. The one or more non-transitory computer-readable storage media of claim 16, wherein the instructions further cause the one or more processors to generate a feature script for presentation of the generated feature game symbol set to a player of the feature game.
